(19) United States
(12) Patent Application Publication
(10) Pub. No.: US 2021/0096927 A1
(43) Pub. Date: Apr. 1, 2021

(54) AUTO-SCALING A POOL OF VIRTUAL DELIVERY AGENTS

(71) Applicant: Citrix Systems, Inc., Fort Lauderdale, FL (US)

(72) Inventors: Xiaofeng Zhu, Weston, FL (US); Yongyu Chen, Nanjing (CN); Jingyi Chen, Nanjing (CN)

(21) Appl. No.: 16/585,498

(22) Filed: Sep. 27, 2019

(51) Int. Cl. G06F 9/50; G06F 9/455; G06F 11/30; G06N 20/00

(52) U.S. Cl. CPC G06F 9/5077; G06F 9/45558; G06F 2009/4557; G06F 11/3075; G06N 20/00; G06F 11/301

(57) ABSTRACT

Systems and methods described herein provide auto-scaling of virtual delivery agent services. The system can identify data indicating consumption of a pool of active virtual delivery agents over a plurality of previous time frames. The system can determine a usage metric for a time frame of the plurality of previous time frames based on the data indicating consumption of the pool of active virtual delivery agents. The system can control, responsive to an auto-scale setting of the pool based on the usage metric, a number of active virtual delivery agents in the pool for a future time frame that corresponds to the time frame of the plurality of previous time frames.

### FIELD OF THE DISCLOSURE

This application generally relates to automatically scaling the number of virtual delivery agents in a pool of virtual delivery agents. This technology can analyze historical data to determine a usage metric for a time fame, and then control an auto-scale setting for the pool based on the usage metric.

### BACKGROUND

Computing services or resources can be provided via a virtual application or virtual desktop, for example, in a client-server architecture. The virtual application or virtual desktop can provide improved security relative to native applications executing on a client device, while also providing access to computing resources from any client device. The virtual application or virtual desktop can be delivered to a client device. Each physical and virtual machine that delivers these applications and desktops can be associated with a virtual delivery agent (“VDA”) that performs various services including, for example, registration, connection brokering, and information management. However, due to the high volume of requests to access virtual applications and virtual desktops, it can be challenging to efficiently deliver services via the virtual applications and virtual desktops if there are an insufficient number of available VDAs, thereby causing delays in delivering the application or desktop.

### BRIEF SUMMARY

This Summary is provided to introduce a selection of concepts in a simplified form that are further described below in the Detailed Description. This Summary is not intended to identify key features or essential features, nor is it intended to limit the scope of the claims included herewith.

Illustrative systems and methods of this technical solution can analyze historical data to determine a usage metric for a time fame, and then control an auto-scale setting for the pool of available VDAs based on the usage metric. The system can determine a fitting curve and a safety buffer value by analyzing the historical data after classifying the workday and weekends. The historical data can include time-series sampled data, which the system can divide into the following four parts: 1) long term usage trend, 2) seasonal data (weekly cycling), 3) cycling data (daily cycling), and 4) irregular (e.g., random noise or spikes). To divide the historical data, the system can use short-term data prediction to determine a stable scaling setting. The system can use deep learning and statistical analysis techniques to generate the fitting curve and safety buffer to simulate the target usage prediction result.

The system can use the fitting curve to determine how many VDA sessions requests are expected in a time interval (e.g., the next 30 minutes). Based on the number of expected VDA session requests, the system can prepare the pool of available VDAs so as to improve scale-up speed.

The system can provide dynamic scaling by using pre-launch tokens that trigger a pre-launch action. The system can place a certain quantity of tokens into data store, which a pool manager service can retrieve and then use to prepare a corresponding VDA prior to receiving a request from a customer session.

The system can check the request density in each checkpoint (e.g., every 5 min) and compare the request density with the expected number of requests. If the system determines the request density is intensive (e.g., greater than the expected or forecasted number of requests for the checkpoint and a safety buffer), the system can trigger a self-protection mechanism and pre-launch additional VDAs to maintain available VDAs in the pool of VDAs throughout the time frame.

The system can include a spike monitor that combats usage spikes and improves the confidence level. The spike monitor can generate alerts and trigger frequency logoff blocking in a firewall system when request spikes are coming from specific customers, computing devices, or internet protocol addresses. Thus, the system can prevent the pool from running out of available sessions to allocate for session requests.

At least one aspect of this technical solution is directed to a method of auto-scaling virtual delivery agent services. The method can include one or more processors identify data indicating consumption of a pool of active virtual delivery agents over a plurality of previous time frames. The method can include the one or more processors determining a usage metric for a time frame of the plurality of previous time frames based on the data indicating consumption of the pool of active virtual delivery agents. The method can include the one or more processors controlling, responsive to an auto-scale setting of the pool based on the usage metric, a number of active virtual delivery agents in the pool for a future time frame that corresponds to the time frame of the plurality of previous time frames.

The data that indicates the consumption can include a time series of requests to access services provided via the pool over the plurality of previous time frames. The one or more processors can generate a fitting curve based on the data indicating consumption of the pool of active virtual delivery agents. The one or more processors can determine the usage metric based on the fitting curve. The usage metric can indicate a number of requests for services provided via virtual delivery agents predicted to occur in the future time frame and prior to receipt of the requests for the services provided via the virtual delivery agents.

The method can include the one or more processors filtering the data indicating consumption of the pool of active virtual delivery agents by removing time frames corresponding to weekends and holidays. The one or more processors can generate a fitting curve based on the filtered data. The one or more processors can determine the usage metric based on the fitting curve generated based on the filtered data.

The method can include the one or more processors filtering the data by removing one or more types of time frames. The one or more processors can input the filtered data into a machine learning component to generate a weekly fitting curve and a daily fitting curve.

The method can include the one or more processors establishing a safety buffer of virtual delivery agents based on the usage metric and a standard deviation of the usage metric for the plurality of previous time frames. The one or more processors can establish the auto-scale setting based on the safety buffer to control the number of active virtual delivery agents in the pool for the future time frame.

The method can include the one or more processors determining, based on the auto-scale setting of the pool, to increase the number of active virtual delivery agents in the pool for the future time frame. The one or more processors can pre-launch, responsive to the determination, one or more virtual delivery agents in accordance with the auto-scale setting.

The method can include the one or more processors determining, for the auto-scale setting, a safety buffer of virtual delivery agents based on the usage metric and a standard deviation of the usage metric for the plurality of previous time frames. The one or more processors can detect a request density for a current time frame. The one or more processors can determine, based on the request density and the safety buffer, to initiate a second safety buffer for the future time frame. The one or more processors can initiate, responsive to the determination, the second safety buffer to increase the number of active virtual delivery agents in the pool during the future time frame.

The method can include the one or more processors generating, responsive to the auto-scale setting of the pool, a pre-launch token for the future time frame. The one or more processors can provide the pre-launch token to a pool manager service to cause the pool manager service to launch a virtual delivery agent for the pre-launch token prior to receiving a session request from a client device.

The method can include the one or more processors detecting a request density associated with a client device or a group of client devices associated with an entity. The one or more processors can determine, based on the request density and the usage metric for the time frame, to disconnect the client device or the group of client devices to maintain a predetermined number of active virtual delivery agents in the pool for the future time frame.

At least one aspect of this technical solution is directed to a system to auto-scale virtual delivery agent services. The system can include a device having one or more processors. The device can identify data indicating consumption of a pool of active virtual delivery agents over a plurality of previous time frames. The device can determine a usage metric for a time frame of the plurality of previous time frames based on the data indicating consumption of the pool of active virtual delivery agents. The device can control, responsive to an auto-scale setting of the pool based on the usage metric, a number of active virtual delivery agents in the pool for a future time frame that corresponds to the time frame of the plurality of previous time frames.

The data indicating the consumption can include a time series of requests to access services provided via the pool over the plurality of previous time frames. The device can generate a fitting curve based on the data indicating consumption of the pool of active virtual delivery agents. The device can determine the usage metric based on the fitting curve. The usage metric can indicate a number of requests for services provided via virtual delivery agents predicted to occur in the future time frame and prior to receipt of the requests for the services provided via the virtual delivery agents.

The device can filter the data indicating consumption of the pool of active virtual delivery agents by removing time frames corresponding to weekends and holidays. The device can generate a fitting curve based on the filtered data. The device can determine the usage metric based on the fitting curve generated based on the filtered data.

The device can filter the data by removing one or more types of time frames. The device can input the filtered data into a machine learning component to generate a weekly fitting curve and a daily fitting curve.

The device can establish a safety buffer of virtual delivery agents based on the usage metric and a standard deviation of the usage metric for the plurality of previous time frames. The device can establish the auto-scale setting based on the safety buffer to control the number of active virtual delivery agents in the pool for the future time frame.

The device can determine, based on the auto-scale setting of the pool, to increase the number of active virtual delivery agents in the pool for the future time frame. The device can pre-launch, responsive to the determination, one or more virtual delivery agents in accordance with the auto-scale setting.

The device can determine, for the auto-scale setting, a safety buffer of virtual delivery agents based on the usage metric and a standard deviation of the usage metric for the plurality of previous time frames. The device can detect a request density for a current time frame. The device can determine, based on the request density and the safety buffer, to initiate a second safety buffer for the future time frame. The device can initiate, responsive to the determination, the second safety buffer to increase the number of active virtual delivery agents in the pool during the future time frame.

The device can generate, responsive to the auto-scale setting of the pool, a pre-launch token for the future time frame. The device can provide the pre-launch token to a pool manager service to cause the pool manager service to launch a virtual delivery agent for the pre-launch token prior to receiving a session request from a client device.

The device can detect a request density associated with a client device or a group of client devices associated with an entity. The device can determine, based on the request density and the usage metric for the time frame, to disconnect the client device or the group of client devices to maintain a predetermined number of active virtual delivery agents in the pool for the future time frame.

### BRIEF DESCRIPTION OF THE FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2 is a block diagram of an example embodiment of a system to automatically scale a pool of VDAs.

FIG. 3 is an example flow chart of a method for automatically scaling a pool of VDAs.

FIG. 4 is an example of a fitting curve used to automatically scale a pool of VDAs.

FIG. 5 is an example of a safety line used to automatically scale a pool of VDAs.

FIG. 6 is an example of a distribution of safety values used to automatically scale a pool of VDAs.

FIG. 7 is an example of a check point to automatically scale a pool of VDAs.

FIG. 8 is an example of a check point to automatically scale a pool of VDAs.

FIG. 9 is an example of a check point to automatically scale a pool of VDAs.

FIG. 10 is an example of a neural network for automatically scaling a pool of VDAs.

FIG. 11 is an example of data used to automatically scale a pool of VDAs.

FIG. 12 is an example of a fitting curve used to automatically scale a pool of VDAs.

FIG. 13 is an example of a fitting curve used to automatically scale a pool of VDAs.

FIG. 14 is an example of a normal probability plot used to automatically scale a pool of VDAs.

FIG. 15 is an example of a forecasting result used to automatically scale a pool of VDAs.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

This technical solution is generally related to automatically scaling the number of virtual delivery agents in a pool of virtual delivery agents. By automatically and dynamically scaling the number of virtual delivery agents in the pool, the technical solution can increase the speed at which the pool scales, provide for flexible scaling on a more granular time interval basis, and combat usage spikes via checkpoint adjustment and frequency log off detection techniques.

For purposes of reading the description of the various embodiments below, the following descriptions of the sections of the specification and their respective contents may be helpful:

Section A describes a computing environment which may be useful for practicing embodiments described herein.

Section B describes systems and methods for automatically scaling a pool of VDAs.

### A. Computing Environment

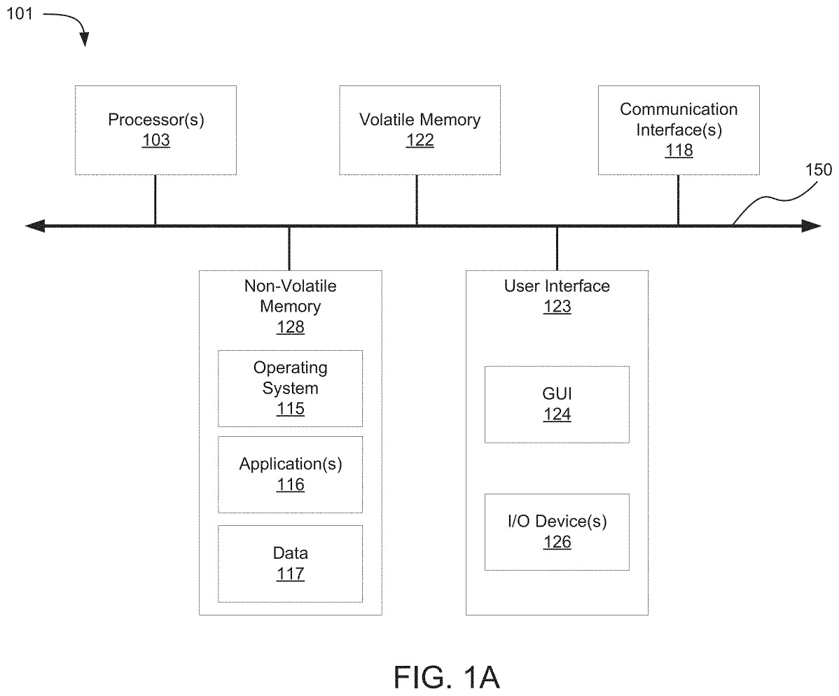

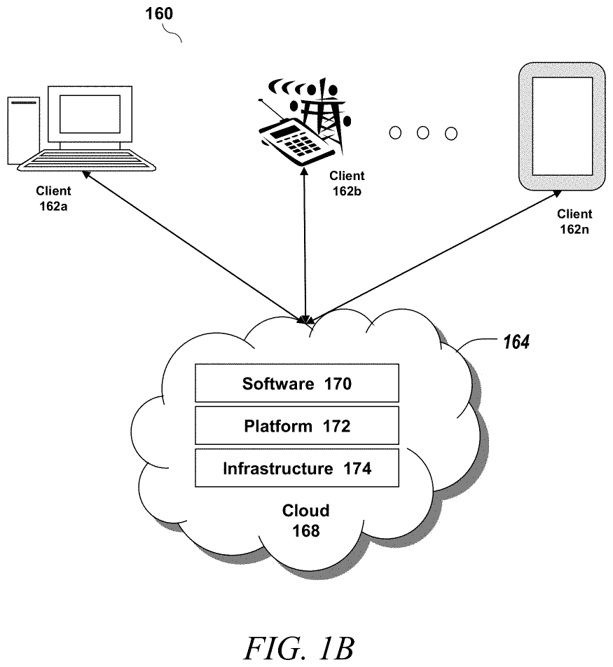

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop to applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 162 may include one or more clients 162a-162n, in communication with a cloud 168 over one or more networks 164. Clients 162 may include, e.g., thick clients, thin clients, and zero clients. The cloud 108 may include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 108 may be public, private, or hybrid. Public clouds 108 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g. Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Systems and Methods for Automatically Scaling a Pool of VDAs

This technical solution is directed towards systems and methods for automatically scaling a pool of virtual delivery agents (“VDAs”). The technical solution can include a system that allows a service to prepare sufficient VDAs for each separated time frame. By automatically and dynamically scaling the number of virtual delivery agents in the pool, the technical solution can increase the speed at which the pool scales, provide for flexible scaling on a more granular time interval basis, and combat usage spikes via checkpoint adjustment and frequency log off detection techniques.

For example, physical or virtual machines can deliver applications or desktops to a client computing device. These applications and desktops can be associated with a VDA that performs various services such as registration, connection brokering, and information management. However, due to the high volume of requests to access virtual applications and virtual desktops, it can be challenging to efficiently deliver services via the virtual applications and virtual desktops if there are an insufficient number of available VDAs, thereby causing delays in delivering the application or desktop.

Further, adjusting the number of available VDAs using a percentage threshold to keep available resources at a reasonable level can pose additional or different challenges. For example, using a percentage threshold can cause a slow scale speed because threshold-based scaling triggers a scale responsive to a certain quantity of resource usage. Waiting for this resource usage to trigger a scale may not be fast enough or responsive enough, especially when it may take several minutes (e.g., 3, 4, 5, 6, 7, 8, 9, or 10 minutes or more) to prepare the VDA for usage. With a threshold, the scale up ability is fixed due to the fixed scale number. The scale up ability may further be limited by the cool down interval. As a result, the threshold-based scaling may not be able to accommodate, adapt, or otherwise effectively respond to sudden increases in resource usage. A percentage threshold may not provide fine-grained scalability, which may lead to resource waste as the cluster scaling becomes larger. Finally, these scaling techniques may not provide or include a risk warning mechanism, as they may not include or be integrated with any monitor that detects spikes and takes actions based on the detection.

Thus, system and methods of this technical solution can automatically and dynamically scale the number of virtual delivery agents in the pool, thereby increasing the speed at which the pool scales, providing for flexible scaling on a more granular time interval basis, and combating usage spikes via checkpoint adjustment and frequency log off detection techniques. Systems and methods of this technical solution can analyze historical data to determine a usage metric for a time fame, and then control an auto-scale setting for the pool of available VDAs based on the usage metric. The system can determine a fitting curve and a safety buffer value by analyzing the historical data after classifying the workday and weekends. The historical data can include time-series sampled data, which the system can divide into the following four parts: 1) Long term usage trend, 2) seasonal data (weekly cycling), 3) cycling data (daily cycling), and 4) irregular (e.g., random noise or spikes). The system can group the historical data into time frames (e.g., 30 minute time frames), and further group the data into weekdays and weekend/holiday training data set. To divide the training data set, the system can use short term data prediction to determine a stable scaling setting. The system can use deep learning and statistical analysis techniques to generate the fitting curve and safety buffer to simulate the target usage prediction result.

The system can determine, predict or forecast the number of VDA sessions requests that are expected to be received in a subsequent time interval (e.g., in the next 10 minutes, 20 minutes, 30 minutes, 45 minutes, 60 minutes, or more). Based on the predicted number of VDA session requests, the system can prepare one or more VDAs and make them available in a pool of VDAs. By preparing VDAs prior to receiving a VDA session request, the system can improve or increase the scale up speed.

To provide this dynamic scaling and prepare VDAs prior to a session request, the system can use pre-launch tokens to trigger a pre-launch action. The system can place, store, associate, or other provide a certain quantity of tokens in a data storage or repository. A pool manager service can identify the pre-launch token and use the pre-launch token to prepare a corresponding VDA before a server receives a session request from a client device. To facilitate the dynamic scaling, the system can establish a safety buffer to check the request density in each checkpoint (e.g., every 2 minutes, 3 minute, 4 minutes, 5 minutes, 7 minutes, 10 minutes, or other time interval). If the system determines the density is intensive (e.g., greater than the expected number of requests and a safety buffer), the system can trigger a self-protection mechanism. The self-protection mechanism can include pre-launching additional VDAs.

To combat the spike and improve a confidence level, the system can use a spike monitor to detect spikes in session requests, and generate alerts or notification responsive to detecting the spike. The spike monitor can interface with a firewall system to trigger frequency logoff blocking, which can include blocking requests for specific client devices or entities (e.g., one or more devices or a group of devices associated with an internet protocol address or other identifier or domain). Thus, the spike monitor can mitigate or prevent the pool of VDAs from running out of available VDAs to allocate to sessions requested from client devices.

The system can generate the fitting curves using historical data. The system can collect historical data from a previous time interval (e.g., the past 30 days, 45 days, 60 days, 1 week, 1 month, 2 months, or other time interval). The historical data can include successful session requests. The system can group, categorize, or separate the historical data into time intervals (e.g., 15 minute time interval, 20 minute time interval, 30 minute time interval, 45 minute time interval, 60 minute time interval, or other time interval). Each data point in the grouped consumption data can represent a request density for each time interval, such as a number of successful requests for a first time frame, a number of successful requests at a second time frame, etc. The system can group the data into a weekday data set and a weekend/holiday data set. The system can filter out portions of the historical data, such as weekends or holidays, to generate the separate weekday and weekend/holiday data sets. For example, the system can filter out or remove data corresponding to session requests that occurred during the weekend (e.g., Saturday and Sunday), or a holiday (e.g., a federal or state holiday).

The system can generate one or more training data sets. The system can generate a training data set that includes information about session requests that occurred on workdays. The system can generate a training data set that includes information about session requests that occurred on non-workdays. The system can apply a data analysis technique to the one or more training data sets to generate weekly and daily fitting curves along with a safety buffer.

The system can establish a safety line for each time frame or time interval (e.g., 30 minutes) based on the fitting curves. For example, the fitting curve can be set as Fₜ, and contain seasonal data Sₜ, cycling data (e.g., daily cycle) Cₜ, and a random component Lₜ. This system can set the predicted fitting curve Fₜ as a predicted safety line and use the predicted safety line to pre-launch VDA sessions at least a predetermined time interval (e.g., 5 minutes, 10 minutes, 15 minutes, 20 minutes, or other time interval) prior to an event (e.g., launch VDA sessions 10 minutes ahead of when the predicted safety line predicts session requests may be received).

For various reasons, the number of session requests can significantly increase in a short time interval and result in a spike. A spike can refer to an increase in requests by a certain percentage (e.g., 10%, 20%, 30%, 40%, 50%, 60% or more) or number (e.g., 2, 3, 4, 5, 6, 7, 8, 9, 10 or more) within a time interval such as 1 minute, 2 minutes, 3 minutes, 4 minutes, 5 minutes, 7 minutes, 10 minutes or other time interval. A spike can refer to request density that exceeds the estimated safety line and a safety buffer value (e.g., a value set based on the safety line, such as three standard deviations of the safety line for the time frame), e.g., 20 requests within first 5 minutes of the time frame, or 35 requests within the first 10 minutes of the time frame. To combat the request spike, the system can monitor a distribution of requests (e.g., if the system estimates 60 requests in 30 minutes, then the system can expect to receive 10 requests every 5 minutes in the time frame). If the system receives requests faster than expected (e.g., more than 10 requests every 5 minutes), the system can trigger or execute a self-protection mechanism. The self-protection mechanism can include pre-launching more VDAs.

Prior to initiating the self-protection mechanism, the system can execute a spike detection mechanism at a checkpoint that is within a larger pre-launch time interval. For example, the system can execute a spike detection mechanism at 5 minute checkpoints within a 30 minute predetermined pre-launch time interval of 30 minutes. At the beginning of a 30 minute time interval, the system can be configured to prelaunch E sessions (e.g., based on the estimated safety line Fₜ for the time frame). After the first 5 minutes of the 30 minute time interval, the system can initiate a first checkpoint. At the first checkpoint, the system can determine the number of session requests that were received in the first five minutes as Rs. Receipt of a session request can refer to or include receiving a request to initiate or establish a session that uses a VDA. Receipt of a session request for the purposes of the checkpoint can refer to or include both receiving a request to initiate or establish a session that uses a VDA, and also successfully establishing the session using the VDA. The system can determine whether the number of session requests, R₅, in the first five minutes of the 30 minute time interval is greater than

$$E * \frac{5}{30} + a$$

session requests. If, for example, the system determines that the number of sessions R₅ established using VDAs in the pool of available VDAs is greater than

$$E * \frac{5}{30} + a .$$

In this case, the system can determine that if this trends continues, the available VDAs in the pool of VDAs, which is configured to prelaunch E sessions, will be consumed prior to completion of the 30 minute time interval. Accordingly, the system can determine to prepare a additional sessions at this point. The number of additional sessions to prepare, a, can be set based on the safety buffer determined using the historical data.

At the second checkpoint, which is five minutes after the first checkpoint or 10 minutes from the beginning of the time interval, the system can determine the number of session requests that were received in the first 10 minutes (R₁₀). Since a additional sessions were prepared after the first checkpoint, the system can determine whether R₁₀−a is greater than

$$E * \frac{10}{30} + a .$$

If R₁₀−a is greater than

$$E * \frac{10}{30} + a ,$$

then the system can determine to prepare a number of additional VDA sessions. Thus, the system can, after each checkpoint, maintain at least a active sessions or available VDAs in the pool of available VDAs as follows. For example, the comparison can be

$${R}_{t} - E * \frac{t}{30} > a ,$$

where t refers to the current check point time (e.g., t can be {5, 10, 15, 20, 25}), Rₜ refers to the number of successful session requests, a refers to the safety buffer, and E refers to the total number of VDA sessions that are forecasted or predicted to be launched for the time frame (and are pre-launched and prepared before the time frame begins so they are available to service requests when the time frame begins).

In some instances, to prevent malicious login attempts, the system can be configured with a limit for each client computing device, domain, account, or other entity or group. The limit can be a limit for a time interval, such as a request density for a time interval, or request rate. If the system detects that number of requests from a client computing device during a time interval exceeds the limit, the system can block further requests from establishing sessions or using VDAs during one or more time intervals, or until access is restored by an administrator of the system or satisfaction of another condition or event.

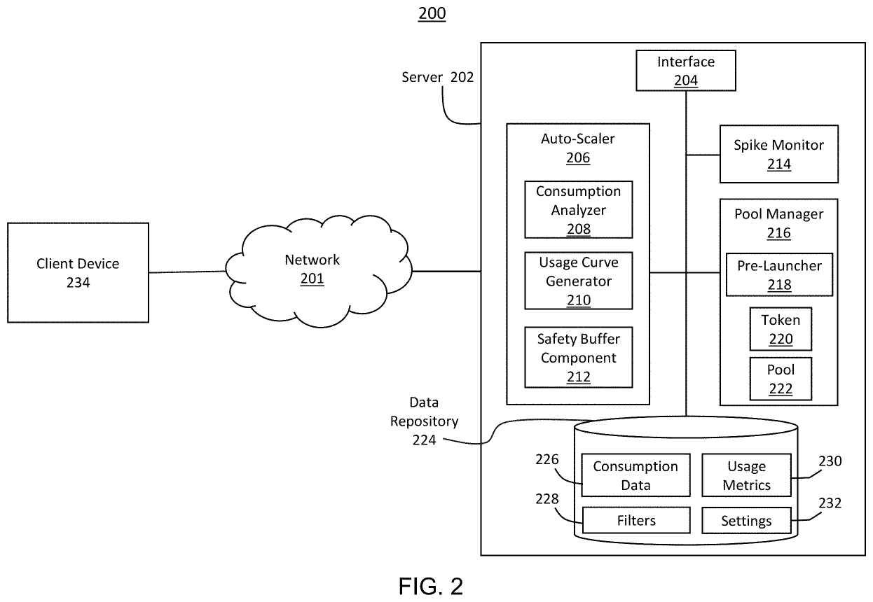

Referring now to FIG. 2, depicted is a block diagram of an example embodiment of a system for auto-scaling virtual delivery agent services. In brief overview, the system 200 can include a server 202. The server 202 can include one or more component or functionality of system 101 depicted in FIGS. 1A-1B. The server 202 can be referred to as a device. The server 202 can include one or more processors that are configured to perform one or more functions. The server 202 can be a device that is intermediary to a client device 234 (e.g., client 162a, 162b, or 162c) and one or more servers (e.g., other servers 202) that provide or deliver resources, applications, or desktops. For example, the server 202 can be an intermediary device. The server 202 can form part of a cloud computing environment containing multiple servers 202 located in a data farm or server farm, or distributed data farm or server farm.

The server 202 can include an interface 204 to communicate with one or more system or component of system 200. The server 202 can include an auto-scaler 206 to analyze historical session request data, generate a fitting curve, and establish a safety buffer. The server 202 can include one or more components or modules, including, for example, a consumption analyzer 208, usage curve generator 210, or safety buffer 212. The server 202 can include a spike monitor 214 configured to detect increases or spikes in session requests received from one or more client devices 234. The server can include a pool manager 216 to manage a pool of VDAs. The pool manager 216 can include one or more components that facilitate managing the pool of VDAs, including, for example, a pre-launcher 218, token 220, or pool 222 of VDAs. The server 202 can include a data repository 224 to store data, data structures, data files, or databases. For example, the data repository 224 can include or store information such as consumption data 226, filters 228, usage metrics 230, or settings 232.

The system 200 can include, interface with or otherwise communicate with a client device 234. The client device 234 can be referred to as a user device, client computing device, computing device, or mobile device. The client device 234 can include, for example, a desktop computing device, laptop computing device, or a mobile computing device such as a smartphone, mobile telecommunications device, wearable computing device, smartwatch, or tablet. The client device 234 can access resources, applications or desktops provided via the server 202. The client device 234 can generate session requests. The client device 234 can transmit session requests via network 201 to server 202 for further processing. The client device 234 can render, receive, or execute resources delivered by the server 202 via network 201.

The server 202 and client device 234 can communicate with one another via network 201. The network 201 can include one or more networks or different types of networks. The network 201 can include a private network such as a local area network (LAN) or a company Intranet, a public network, such as a wide area network (WAN) or the Internet. The network 201 can employ one or more types of physical networks and/or network topologies, such as wired and/or wireless networks, and can employ one or more communication transport protocols, such as transmission control protocol (TCP), internet protocol (IP), user datagram protocol (UDP) or other similar protocols.

Each of the above-mentioned elements or entities can be implemented in hardware, software or a combination of hardware and software, in one or more embodiments. Each component of the system 200, such as the auto-scaler 206, spike monitor 214, or pool manager 216, can be implemented using hardware or a combination of hardware or software detailed above in connection with FIG. 1. For instance, each of the elements, components or entities shown in FIG. 2 can include any application, program, library, script, task, service, process or any type and form of executable instructions executing on hardware (e.g., of the client device). The hardware includes circuitry such as one or more processors in one or more embodiments.

The server 202 can form part of a cloud computing environment (e.g., cloud 168) that provides computing resources. The cloud computing environment can include configuration components, delivery controllers, file servers, or monitors to facilitate delivering resources. The computing environment or server 202 can provide resources that can include cloud connectors (e.g., authentication component, proxy component, provisioning component, or identity component). The cloud computing environment can provide hypervisors that can provide server VDAs and desktop VDAs. Thus, the cloud computing environment (e.g., one or more servers 202) can include various components that facilitate delivering applications using virtual machines.

Each physical or virtual machine that delivers applications and desktops via the servers 202 can have a VDA. The VDA registers with a connector component of the cloud computing environment. After registration, connections can be brokered from those resources to client devices 234. VDAs can establish and manage the connection between the machine and the client device 234, and apply policies that are configured for the session. The VDA can communicate session information to the connector component through a broker agent in the VDA. The broker agent can hosts multiple plugins and collect real-time data. VDAs can be available for server and desktop operating systems. VDAs can allow one or more client devices 234 to connect to the server or cloud computing environment at one time. VDA can refer to the agent and the physical or virtual machine on which it is installed.

Still referring to FIG. 2, and in further detail, the server 202 can include an interface 204 designed, constructed, or operational to communicate with one or more components of the server 202, or one or more components or devices external or remote from the server 202. The interface 204 can include a data interface, network interface, communication interface, user interface, graphical user interface, or other types of interface that can receive input or provide output. The interface 204 can include a hardware interface or software interface, or combination of hardware and software. The interface 204 can include or provide an application programming interface. The interface 204 can receive session requests or other requests to access resources provided by or via the server 202. The interface 204 can receive requests, commands, queries, or other information or data from a client device 234. The interface 204 can route communications, such as data packets, received via network 201 to one or more component of the server 202 or other devices or servers associated with, or communicatively coupled with the system 200.

The server 202 can include an auto-scaler 206 designed, constructed and operational to facilitate auto-scaling of virtual delivery agent services. The auto-scaler 206 can analyze historical data, filter the historical data, generate a fitting curve based on the filtered historical data, determine a usage metric and a safety buffer, and determine a number of VDAs to pre-launch beforehand for a time interval. For example, the auto-scaler 206 can include a consumption analyzer 208 designed, configured and operational to identify data indicating consumption of a pool of active virtual delivery agents over a plurality of previous time frames. The data can include or refer to historical data. The data, or historical data, can be stored in data repository 224 as consumption data 226.

Consumption data 226 can indicate a level of usage or consumption of VDAs for a previous time interval. Consumption data 226 can include information about previous requests to establish VDA sessions or access resources, such as applications or desktops, provided via a VDA. Consumption data 226 can include information about each session request. Consumption data 226 can include information indicating consumption of a pool of active VDAs over one or more previous time frames. The consumption data 226 can include time series data. For example, the consumption data 226 can include a time series of requests to access services provided via a pool of VDAs over one or more previous time frames.

Consumption data 226 can include parameters and values for the parameters. For example, consumption data 226 can include a data structure, table, or index storing, for each session request, one or more of an identifier of the source of the request, an identifier of a destination of the request, a timestamp associated with the request, an indication as to the status of the request, or information about what was requested (e.g., identifier of an application, type of application, type of desktop). The status of the request can include, for example, whether the request resulted in successfully establishing a session using a VDA. The consumption data 226 can include performance information associated with the session request or session. Performance information can include an amount of time the system took to establish the session responsive to the request or the amount of time the system took to deliver the resource responsive to the request. Performance information can include computing resource utilization by the session, such as memory utilization, processor utilization, storage utilization, or network bandwidth utilization.

The consumption analyzer 208 can monitor session requests and detect information associated with usage of the VDAs for storage in the data repository 224 as consumption data 226. The server 202 can otherwise obtain consumption data 226 and store the consumption data 226 in data repository 224. The server 202 can access one or more remote servers or databases to obtain consumption data 226. In some cases, the consumption data 226 can be stored on a data repository or file server that is remote from the server 202.

For example, each time the server 202 receives, detects, or otherwise identifies a session request, the server 202 can store, in data repository 224, information associated with the session request and a timestamp (e.g., date and time in any format, such as yyyy-MM-dd hh:mm:ss am or pm, d MMM yyyy HH:mm:ss, or yyyy/MM/dd HH:mm:ss timezone) for the session request. The server 202 can update the information for the session request based on additional characteristics associated with the session, such as whether the session was successfully established, duration of the session, performance of the session, etc.

The consumption data 226 can include historical consumption data. Historical consumption data can refer to or include data for the past 2 weeks, 30 days, 1 month, 2 months, 3 months, 4 months, 5 months, 6 months, 8 months, 10 months, year or more. Historical consumption data can be stored as raw data, which can refer to data that has not been filtered or pre-processed. The consumption data with timestamps can form time series data. Time series data can refer to a series of data points indexed in time order, such as a sequence of data points taken at successive points in time. The time series consumption data points can be equally spaced about, or not equally spaced apart. For example, the time series consumption data can refer to a sequence of data points corresponding to VDA sessions that may or may not have occurred at equally spaced intervals.

The consumption analyzer 208 can identify data indicating consumption of a pool of active virtual delivery agents over previous time frames. The consumption analyzer 208 can access data repository 224 to obtain the data from the consumption data 226 data structure. The consumption analyzer 208 can be configured to process the data to facilitate auto-scaling VDA services. The consumption analyzer 208 can apply one or more filters to the raw consumption data or grouped consumption data. The consumption analyzer 208 can access one or more filters 228 stored in data repository 224. The consumption analyzer 208 can select a filter to apply from filters 228. Example filters 228 can include: 1) a filter configured to group or remove data points with timestamps corresponding to a type of time frame (e.g., weekend); 2) a filter configured to remove data points with timestamps corresponding to a holiday (e.g., a federal or state holiday recognized in a geographic region corresponding to the location of the client device 234 that initiated the session request, or a federal or state holiday recognized in a geographic region corresponding to the location of the server 202, entity associated with the server 202, an entity associated with the resource, application or desktop being requested, or an entity associated with the client device 234); 3) a filter configured to remove data points associated with unsuccessful session requests; 4) a filter configured to remove data points associated with requests that do not utilize a VDA from the pool of VDAs; 5) a filter configured to remove data points that are erroneous or missing values for required parameters (e.g., missing a timestamp, missing application data, missing performance data, etc.); 6) a filter configured to remove data points associated with timestamps that fall outside a time window; or 7) a filter configured to perform a deduplication technique to remove redundant data points.

The consumption analyzer 208 can analyze the consumption data to group, organize or otherwise categorize the consumption data into one or more categories. The consumption analyzer 208 can categorize the consumption data for different purposes or different types of processing. For example, the consumption analyzer 208 can generate a set of data from the consumption data that is suitable for determining a long term usage trend, seasonal data trends, weekly cycling data trends, daily cycling data trends, and irregular data (e.g., random noise which may correspond to spikes).

The consumption analyzer 208 can group, categorize, or separate the historical data into time intervals (e.g., 15 minute time interval, 20 minute time interval, 30 minute time interval, 45 minute time interval, 60 minute time interval, or other time interval). The consumption analyzer 208 can group the requests into time frames to generate a time series of request densities. For example, the time series request density can indicate the number of requests that are received during each time frame (e.g., 10 requests at a first time frame, 30 requests in a second time frame, etc.). The consumption analyzer 208 can filter out portions of the historical data, such as weekends or holidays. The consumption analyzer 208 can generate one or more training data sets (e.g., filtered consumption data). The consumption analyzer 208 can generate a training data set that includes information about session requests that occurred on workdays (e.g., Monday through Friday). The system can generate a training data set that includes information about session requests that occurred on non-workdays (e.g., weekends and holidays)

By grouping and/or filtering the consumption data and generating a training data set, the consumption analyzer 208 can improve data processing efficiency by the server 202 (or one or more component thereof) by reducing the amount of the data that is processed, or preventing processing errors by filtering out erroneous data prior to processing. In some cases, the consumption analyzer 208 can perform a data error correction technique. For example, the consumption analyzer 208 can determine that a value for a parameter is missing from the consumption data, determine the value itself or obtain the value from another source, and then update the consumption data to include the value. In another example, the consumption analyzer 208 can determine that a format for a data point or value is incorrect or inconsistent, and then reformat the data point. The consumption analyzer 208 can determine to update, correct or otherwise modify the values in the consumption data 226 data structure, or determine to create a new entry in the data repository 224 for the modified consumption data so as to maintain the raw consumption data.

The consumption analyzer 208 can generate a filtered set of consumption data for further processing by one or more component of the server 202. The consumption analyzer 208 can store the filtered data set in data repository 224 or forward to one or more component of the server 202 (e.g., directly forward or forward via interface 204). The consumption analyzer 208 can filter the consumption data 226 to remove one or more types of time frames.

Types of time frames can correspond to day, night, morning, afternoon, evening, types of days, days of the week, vacation days, vacation weeks, or holidays. For example, the consumption analyzer 208 can apply a filter to the raw data to remove requests that occurred in time frames that correspond to weekends (e.g., Saturdays and Sundays) and holidays (e.g., federal holidays).

The system 200 (or server 202 or auto-scaler 206) can include a usage curve generator 210 designed, constructed and operational to generate one or more curves based on the consumption data 226. The usage curve generator 210 can generate a fitting curve based on the consumption data 226. The usage curve generator 210 can generate fitting curve using filtered data (e.g., data filtered by the consumption analyzer 208). The usage curve generator 210 can generate a fitting curve based on the data indicating consumption of the pool of active virtual delivery agents. The usage curve generator 210 can use one of more fitting techniques and apply the fitting techniques to the consumption data (or filtered consumption data) to generate a fitting curve.

The usage curve generator 210 can generate fitting curves that indicate long term usage trends, seasonal data, weekly cycling, daily cycling, or irregularities such as random spikes. The usage curve generator 210 can be configured with machine learning techniques and statistical techniques to identify or generate fitting curves for some or all of the consumption data. The usage curve generator 210 can be configured with seasonal data analyzes techniques to generate weekly and daily fitting curves.

To generate the fitting curves, the usage curve generator 210 can obtain the usage data. The training data set or filtered consumption data containing time series data. The auto-scaler 206 (e.g., via consumption analyzer 208 or usage curve generator 210) can divide the consumption data into several parts, and use one or more of the parts of the consumption data to generate a fitting curve. For example, the auto-scaler 206 can divide the consumption data into four parts that include long term usage data, weekly cycling data, daily cycling data, and irregular data. The auto-scaler 206 can then use the weekly cycling data, daily cycling data, and random part for further processing.

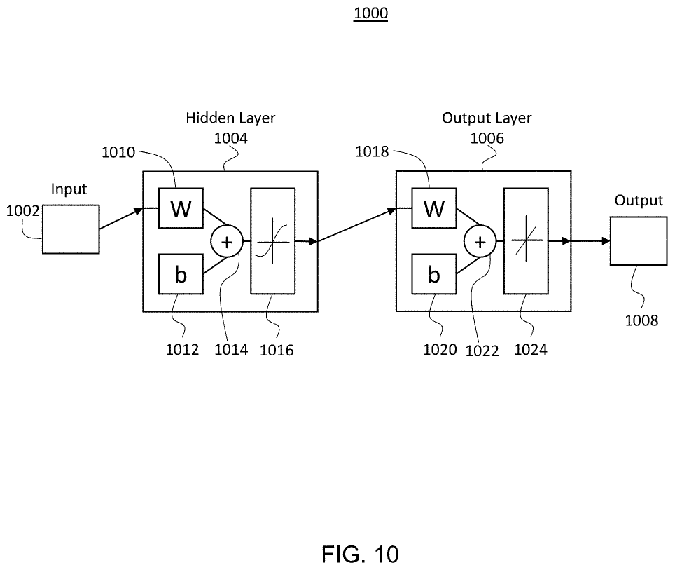

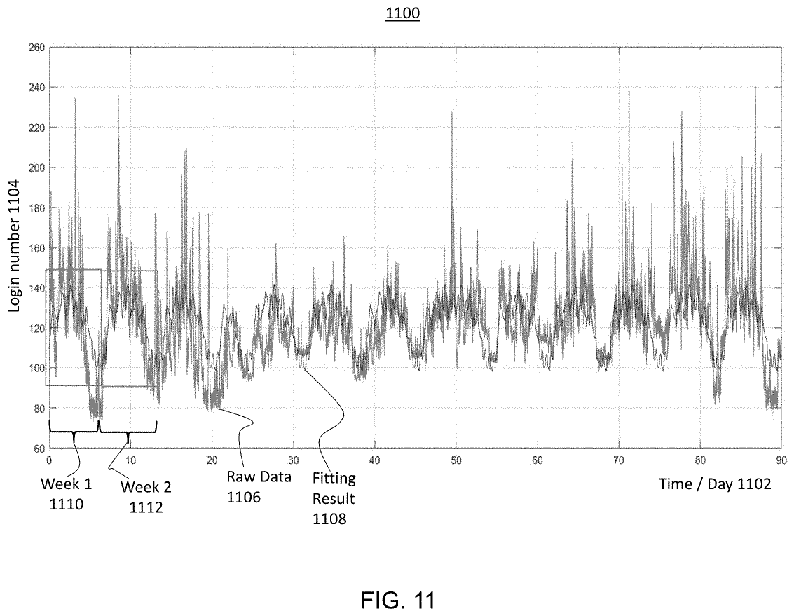

For example, the consumption data 226 can include historical data for one or more previous time intervals. The auto-scaler 206 can generate a data set of usage data referred to as Rₜ that corresponds to usage data related to a seasonal part (e.g., weekly cycle) referred to as Sₜ, a daily cycling part referred to as Cₜ, and a random part referred to as Lₜ. The consumption analyzer 208 or usage curve generator 210 can generate these three parts of data Sₜ, Cₜ, and Lₜ. To identify these three parts of the data, the consumption analyzer 208 or usage curve generator 210 can be configured with a machine learning engine, neural network or regression analysis. The usage curve generator 210 can input the filtered data into a machine learning component to generate a weekly fitting curve and a daily fitting curve. For example, the consumption analyzer 208 or usage curve generator 210 can be configured with or include a two or more layer feed-forward neural network as illustrated in FIG. 10. The auto-scaler 206 can use a moving average, or machine learning or a deep learning technique to generate a fitting result that smooths the data and removes the random part Lₜ in order to identify the usage trend. The usage data with the random part removed by the moving average or deep learning technique (e.g., a two-layer feed-forward neural network) can be referred to as usage data Dₜ. FIG. 11 illustrates an example of a fitting result that smooths the data and removes the random part Lₜ, which are illustrated as spikes in the raw data 1106.

The auto-scaler 206 can then identify the weekly seasonal data Sₜ from the usage data Dₜ that does not include the random part Lₜ. To do so, the auto-scaler 206 can use, for example, a sinusoidal regression technique (e.g., a 3-level sinusoidal regression). The regression technique can use a sinusoidal model to approximate a sequence or generate a fitting curve. A sinusoidal model can approximate the seasonal data Sₜ. The auto-scaler 206 can use one or more sinusoids to generate the approximation. For example, the auto-scaler 206 can use a sinusoidal regression technique in which the auto-scaler 206 adjusts values of coefficients a1, b1, c1, a2, b2, c2, a3, b3 and c3 in the equation f(x)=a1*sin(b1*x+c1)+a2*sin(b2*x+c2)+a3*sin(b3*x+c3), to fit a given set of consumption data (e.g., usage data Dₜ, training data or filtered data set) and identify Sₜ.

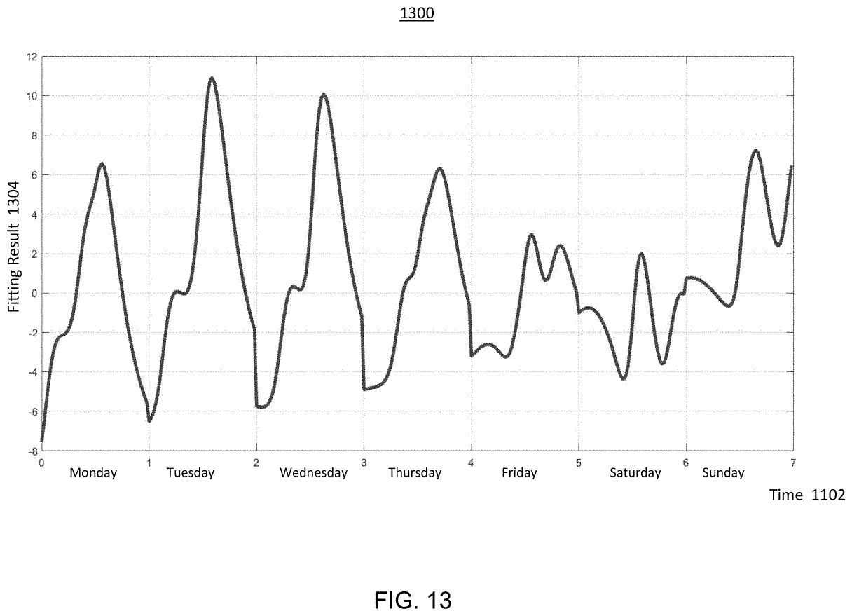

Upon identifying Sₜ from Dₜ (which does not include the random part Lₜ) using a sinusoidal regression technique, the auto-scaler 206 can identify the daily cycling part Cₜ by subtracting Sₜ from Rₜ (e.g., Rₜ−Sₜ) and using a deep learning technique as illustrated in FIG. 10. After removing the weekly seasonal usage trend, the auto-scaler can generate a weekly fitting result as illustrated in FIG. 13.

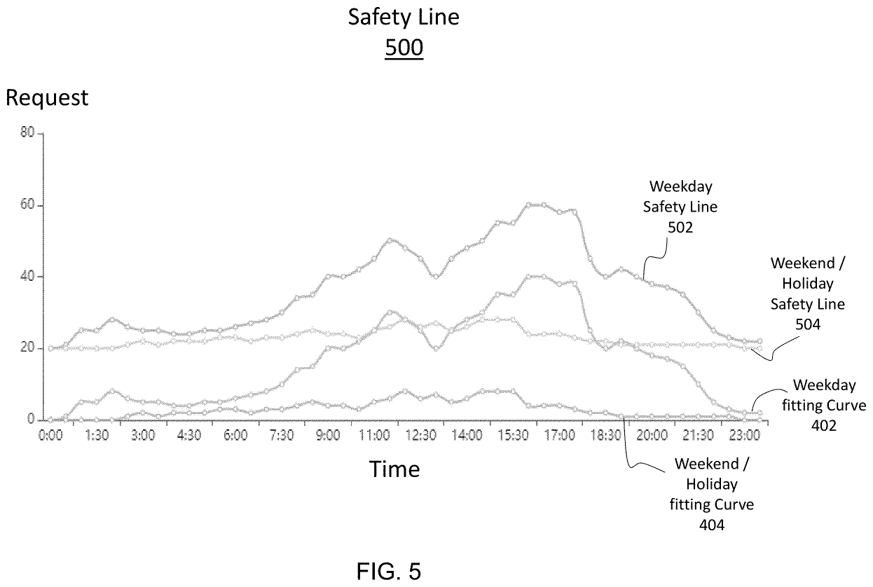

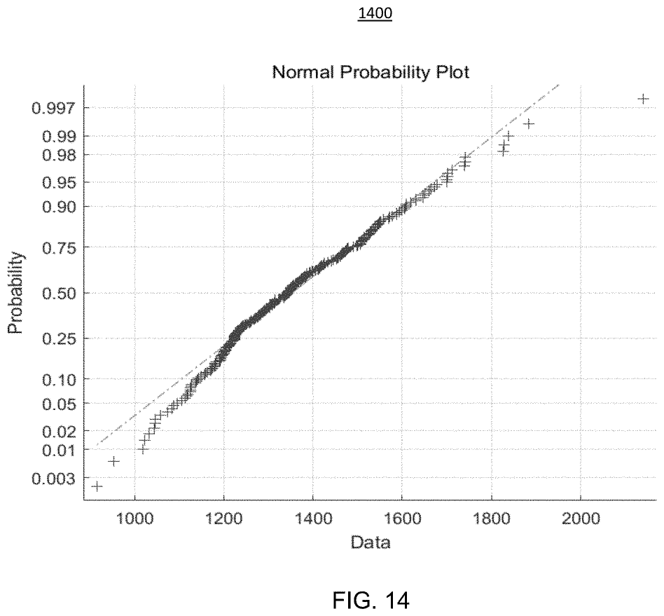

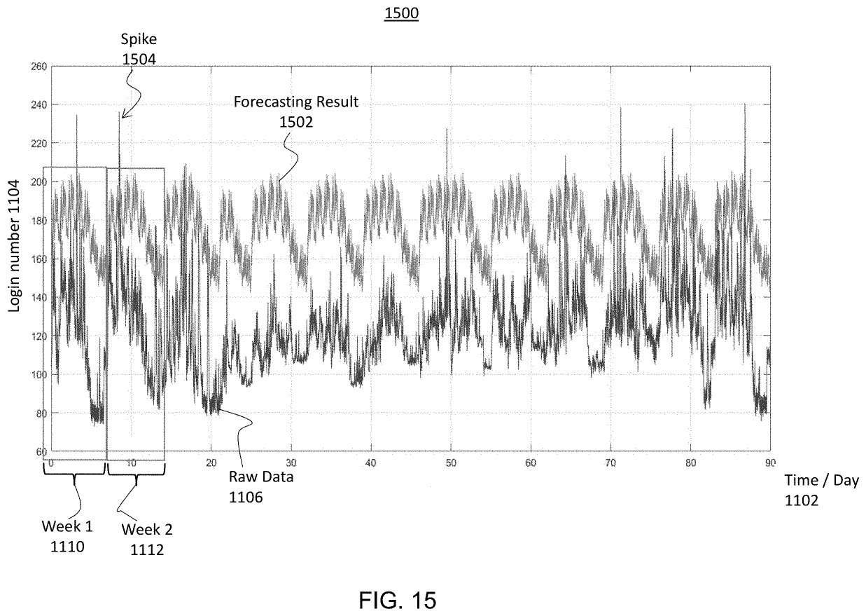

The auto-scaler 206 can validate the weekly fitting result using statistical techniques or metrics such as goodness of fit, or a normal probability distribution plot as illustrated in FIG. 14. The auto-scaler 206 can then determine a forecasting result which is a combination of the fitting curves and fitting results as follows: Fₜ=Sₜ+Cₜ+Lₜ. Thus, the forecasting result Fₜ (which can be referred to as a safety line) can be combination of the weekly cycling curve, daily cycling curve, and random parts, where each part is separately estimated. An example of a forecasting result Fₜ (or safety line) is illustrated in FIG. 5 (e.g., weekday safety line 502 or weekend/holiday safety line 504) or FIG. 15.

The auto-scaler 206 can determine a usage metric (e.g., a login number of the forecasting result Fₜ 1502 of FIG. 15) for a time frame (e.g., a 30 minute window on Monday in Week 1 1110 of FIG. 15) of multiple previous time frames based on the data indicating consumption of the pool of active virtual delivery agents. This usage metric can correspond to the forecasting result Fₜ generating using one or more fitting curves applied to raw consumption data. The usage metric can indicate a number of predicted login requests or session requests that are to occur during a time frame.

The auto-scaler 206 can establish a safety line (e.g., Fₜ or weekday safety line 502 or weekend/holiday safety line 504 illustrated in FIG. 5) for each time frame or time interval (e.g., 30 minutes) based on the fitting curves. For example, the fitting curve can be set as Fₜ, and contain seasonal data Sₜ, cycling data (e.g., daily cycle) Cₜ, and a random component Lₜ. This system can set the predicted fitting curve Fₜ as a predicted safety line and use the predicted safety line to pre-launch VDA sessions at least a predetermined time interval (e.g., 5 minutes, 10 minutes, 15 minutes, 20 minutes, or other time interval) prior to an event (e.g., launch VDA sessions 10 minutes ahead of when the predicted safety line predicts session requests may be received). For example, if weekday safety line 502 of FIG. 5 indicates 40 login requests occurring during a 30 minute time frame corresponding to 9 to 9:30 AM on a weekday, then the auto-scaler 206 can determine to pre-launch 40 VDAs before 9 AM (e.g., 8:50 AM if it takes 10 minutes to launch a VDA). The auto-scaler 206 can store the safety line or Fₜ in usage metrics 230 for further use by the server 202 or components thereof.

The auto-scaler 206 can include a safety buffer component 212 (or safety buffer generator or safety buffer) designed, constructed and operational to determine or generate a safety value or safety buffer or safety buffer value. To mitigate the likelihood that the pool of VDAs runs out of available VDAs, and to facilitate accounting for spikes or varied distribution of requests, the safety buffer component 212 can generate a safety buffer value. For various reasons, the number of session requests can significantly increase in a short time interval and result in a spike. A spike can refer to an increase in requests by a certain percentage (e.g., 10%, 20%, 30%, 40%, 50%, 60% or more) or number (e.g., 2, 3, 4, 5, 6, 7, 8, 9, 10 or more) within a time interval such as 1 minute, 2 minutes, 3 minutes, 4 minutes, 5 minutes, 7 minutes, 10 minutes or other time interval. A spike can refer to a rate of requests that exceeds a predetermined threshold, such as 2 requests a minute, 3 requests per minute, 4 requests per minute, 5 requests per minute, 6 requests per minute, or more. To combat the request spike, the system can monitor a distribution of requests. If the system receives requests faster than expected, the system can trigger or execute a self-protection mechanism. The self-protection mechanism can include pre-launching more VDAs.

To help prevent the system from running out of VDAs in the pool due to spikes (e.g., spike 1504), the safety buffer component 212 can generate a safety buffer value a. The safety buffer component 212 can determine the safety buffer value a to be the maximum standard deviation (e.g., 3) of Fₜ or the forecasting result 1502. By setting the safety value a to be the mean value plus 3 times standard deviation, the safety value a can cover 99.9% samples. To account for the 0.01% not accounted for by the safety value a, the server 202 can use a spike monitor 214 that detects malicious user login and address the spikes with check point adjustment and frequency login fire wall.

The safety buffer component 212 can set the safety buffer value based on a statistical analysis of the usage data, a default value, an initial default value, a predetermined value set by an administrator of the system, or other value. The safety buffer component 212 can update or modify the safety buffer value for each time frame or time interval based on statistical characteristics of the time frame or time interval (e.g., the standard deviation of data of the time frame). The safety buffer value can be stored in usage metrics 230 data structure. Thus, the usage metrics 230 can include safety line values and safety buffer values for multiple time frames, and the server 202 establish a safety buffer of virtual delivery agents based on the usage metric and a standard deviation of the usage metric for the previous time frames. The server 202 can establish the auto-scale setting based on the safety buffer to control the number of active virtual delivery agents in the pool 222 for the future time frame.

The server 202 can include a spike monitor 214 designed, configured and operational to account for the 0.01% spikes not accounted for by the safety value a. The spike monitor 214 can detect malicious user login and address the spikes with check point adjustment and frequency login fire wall. The spike monitor 214 can execute a spike detection mechanism at checkpoints throughout a time frame to prevent malicious login attempts. The spike monitor 214 can be configured with a limit (e.g., stored in settings 232) for each client computing device, domain, account, or other entity or group. The limit can be a log in limit for a time interval, such as a request density for a time interval, or request rate. If the spike monitor 214 detects that number of requests from a client computing device during a time interval exceeds the limit, the server 202 can block further requests from establishing sessions or using VDAs during one or more time intervals, or until access is restored by an administrator of the system or satisfaction of another condition or event. Thus, the spike monitor 214 can detect a request density (e.g., number of requests in a time frame or a time segment corresponding to a checkpoint) associated with a client device 234 or a group of client devices 234 associated with an entity (e.g., the same domain, IP address, organization, or company). The spike monitor 214 can determine, based on the request density and the usage metric for the time frame (e.g., based on the safety line Fₜ for the time frame which indicates the number of VDA session to pre-launch, or also based on the safety buffer value a for the time frame), to disconnect the client device or the group of client devices to maintain a predetermined number of active virtual delivery agents (e.g., Fₜ) in the pool for the future time frame.

The server 202 can include a pool manager 216 designed, constructed and operational to manage a pool 222 of VDAs. The pool 222 of VDAs can refer to a collection of identifiers corresponding to available or active VDA sessions. The pool manager 216 can include a service, script, or component that can launch VDAs, terminate VDAs or otherwise allocate and manage VDAs. To do so, the pool manager 216 can include a data store of tokens 220. The tokens 220 can refer to pre-launch tokens used to launch a VDA. A token can include information used by the pool manager 216 to launch a VDA, such as a unique identifier of a VDA, configuration settings for the VDA (e.g., as obtained from settings 232), parameters of the VDA, or other information used by the pool manager 216 to launch a VDA prior to a request. The auto-scaler 206 can generate the tokens and provide them to the pool manager 216 for storage. In some cases, the auto-scaler 206 can provide an indication of how many VDAs to pre-launch, and the pool manager 216 can generate and store tokens 220 for use by the pre-launcher 218.

The pool manager 216 can obtain the safety line and safety buffer value for a time frame from the usage metrics 230 data structure. The pool manager 216 can perform a lookup in usage metrics 230 for a time frame to obtain the safety line value and a safety buffer value for the time frame. The pool manger 216 can perform the lookup on a periodic basis, such as once for each 30 minute time interval. The pool manager 216 can, responsive to determining the safety line value and safety buffer value, generate one or more tokens for storage in the token 220 data store in order to cause the pre-launcher 218 to pre-launch one or more VDAs. In some cases, the auto-scaler 206 can generate, responsive to the auto-scale setting of the pool, a pre-launch token for the future time frame (e.g., an upcoming 30-minute time interval). The auto-scaler 206 can provide the pre-launch token to the pool manager 216 service to cause the pool manager 216 service to launch a virtual delivery agent for the pre-launch token prior to receiving a session request from a client device 234

The pool manager 216 can include a pre-launcher 218 designed, constructed and operational to identify a token from the token data store 220 and launch a VDA prior to a request from a client device 234 to establish a session using the VDA. For example, the pre-launcher 218 can launch a VDA in a manner that is not responsive to a request for a resource from the client device 234, but may be prior to transmission of the request by the client device to the server 202, or prior to receipt of the request by the server 202. By pre-launching the VDA, the pool manager 216 can reduce latency or delays in delivering a resource requested by a client device 234 because the VDA used to provide the resource has already been launched and prepared.

The pre-launcher 218 can use default settings from settings 232 data structure to launch and prepare a VDA responsive to a token 220. The default settings can be based on historical parameters associate with consumption data 226 for a time frame. For example, there may be different configurations or types of VDAs. To facilitate preparation of VDAs containing the configuration matching a future request from a client device 234, the pool manager 216 can identify historical configurations of VDAs used during a corresponding time frame, and use the same configurations to pre-launch. The pool manager 216 can identify the most common configurations used during a time frame, or use a lowest common denominator of configurations. For example, if all VDAs that were previously launched from 9 to 10 AM on Mondays had one or more settings or configurations in common, then the pre-launcher 218 can pre-launch VDAs with those common configurations, and make those VDAs available in the pool 222 of VDAs.

Thus, the server 202 (e.g., via one or more of auto-scaler 206, pool manager 216, and spike monitor 214) can control, responsive to an auto-scale setting of the pool 222 based on the usage metric 230, a number of active virtual delivery agents in the pool 222 for a future time frame that corresponds to the time frame of the plurality of previous time frames. The auto-scale settings can refer to a number of VDAs to pre-launch based on the safety line and safety buffer value for a future time frame that corresponds to a historical previous time frame in Fₜ. For example, if the forecasted usage metrics 230 include a safety line indicating that 30 login requests historically occur on Mondays from 9 to 9:30 AM, then the auto-scale setting can be based on an even distribution of 30 VDAs over six 5-minute intervals. The auto-scale setting can indicate to pre-launch 5 additional VDAs every 5 minutes in the 30-minute time interval. Thus, the system can begin pre-launching VDAs before 9 AM on Monday (e.g., beginning at 8:50 AM on Monday).

The auto-scale setting can be based on the usage metrics 230, which can include the safety line value and a safety buffer value. The auto-scale setting can be based on a comparison of a current number of VDAs available in a pool with a safety line and a safety buffer. The server 202 can determine the usage metric based on a fitting curve (e.g., a safety line Fₜ). The usage metric can be a value of Fₜ at a time frame or time period and indicates a number of requests for services provided via virtual delivery agents predicted to occur in the future time frame and prior to receipt of the requests for the services provided via the virtual delivery agents.

The usage metric can be determined from a fitting curve that is generated based on filtered consumption data, such as weekday consumption data. The fitting curve can correspond to a weekday daily usage cycle. The usage metric can be based on the daily fitting curve and take into account a random component, which can have a normal distribution over corresponding time frames for corresponding days (e.g., random parts on all 9-10 AM time slots on Mondays or weekdays can have a normal distribution as illustrated in FIG. 14).

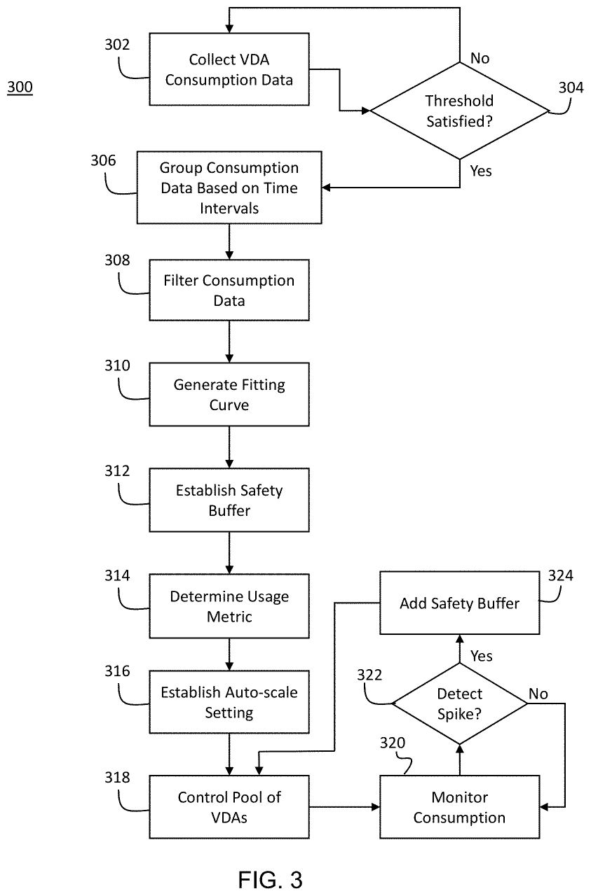

FIG. 3 is an example flow chart of a method for automatically scaling a pool of VDAs. The functionalities of method 300 can be implemented using, or performed by, the components depicted and described in FIGS. 1, 2 and 10. For example, the method 300 can be performed by a server, one or more processors, an auto-scaler, pool manager, or spike monitor. The illustrated embodiment of the method 300 is merely an example. Therefore, it should be understood that any of a variety of operations may be omitted, re-sequenced, and/or added while remaining within the scope of the present disclosure.

At ACT 302, a server collects VDA consumption data. The VDA consumption data can refer to actual usage of VDAs, which can correspond to successful requests from client devices 234 to establish a VDA session in order to access a virtual application, virtual desktop, or other resource. The consumption data can include a time series of data. Each session requests can correspond to a log in request or number, and a timestamp. Additional information for each data point can include, for example, identifiers associated with the device making the request, IP addresses, type of session, configuration of the VDA, performance information, or duration of the session. The consumption data can be stored in a data repository.

At decision block 304, the server can determine whether a threshold amount of consumption data has been received. The threshold can be a number of requests or an amount of time. For example, the threshold can be 30 days or 1 month of consumption, 1 week of consumption, 2 months of consumption, or other time period. The threshold can be an amount of consumption data (e.g., 500 requests, 1000 requests, 1500 requests or other amount). The threshold can be both a duration and an amount, such as 5000 requests in a month. If the threshold is satisfied at decision block 304, then the server can proceed to ACT 306. If the threshold is not satisfied at decision block 304, then the server can return to ACT 302 to collect additional VDA consumption data until there is sufficient historical consumption data to perform further processing.

At ACT 306, the server can group the consumption data based on time intervals. The server can group the consumption data into predetermined time intervals, such as 30 minute time intervals. Grouping the data into 30-minute time intervals can refer to aggregating the number of requests received during each 30-minute time interval and generating a single data point representing the number of successful requests for that 30 minute time interval. The grouped consumption data can indicate a number of successful requests for each 30 minute time interval (or other time frame). The time frame selected for grouping the consumption data can be the time frame used to pre-launch VDA sessions. The grouped consumption data can refer to a request density as it indicates the number of requests per time frame (e.g., 20 requests during a 30 minute time frame).

At ACT 308, the server can filter the consumption data. Filtering the consumption data can refer to separating the grouped consumption data into weekday consumption data and weekend/holiday consumption data (e.g., weekdays can be Monday-Friday, weekends can be Saturday and Sunday, holidays can be state or federal holidays or other non-work days established by a government or organization). The server can apply various filters, such as remove data points with requests that are less than a threshold number (e.g., less than 2 or less than 1 request for a 30-minute time interval).

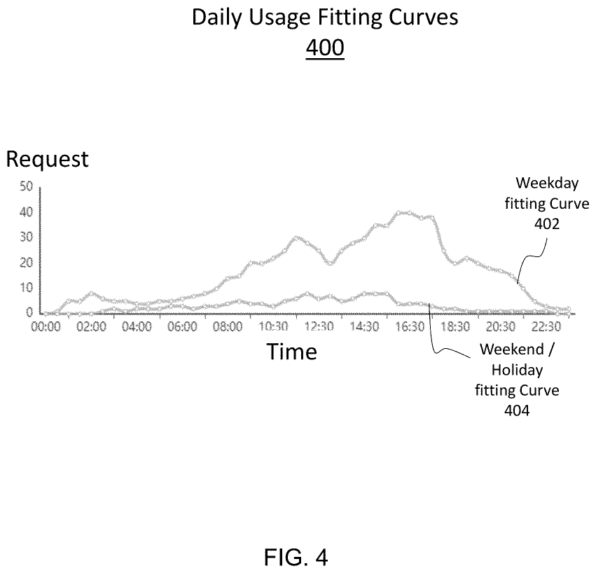

At ACT 310, the server can generate one or more fitting curves. The server can generate fitting curves for the weekday consumption data and the weekend/holiday consumption data. The server can generate a fitting curves by removing or smoothing spikes, irregularities or random noise. The server can generate a fitting curve by removing seasonal cycling components. For example, the server can generate fitting curves 402 and 404 indicated in FIG. 4. The server can generate a safety line, such as safety lines 502 and 504 depicted in FIG. 5, based on the fitting curves 402 and 404. The server can utilize neural networks, deep learning engines, machine learning, moving averages, statistical analysis, logistic regression or other techniques to generate the fitting curves and safety line.

At 312, the server can establish a safety buffer. Establishing a safety buffer can refer to establishing a value to be used as a safety buffer. The value can indicate the number of additional VDAs to pre-launch after a check point in a time frame. The safety buffer value can be a predetermined fixed value, can be set by an administrator of the server or resources provided by the server, or based on a statistical analysis (e.g., 1, 2 or 3 standard deviations of the safety line or a fitting curve for a time frame). The safety buffer value can be fixed for all time frames, or vary for each time frame based on a statistical analysis of the safety line Fₜ for the time frame. For example, the server can select a value for the safety buffer for an upcoming time frame based on three standard deviations of Fₜ for the upcoming time frame.

At 314, the server can determine a usage metric. The usage metric can refer to an estimated safety line value for the upcoming time frame. The estimated safety line value for the upcoming time frame can be determined from Fₜ, as indicated by safety lines 502 and 504 in FIG. 5. For example, the weekday usage metric for a time frame at 0:00 is 20, and the weekday usage metric for a time frame at 9:00 AM is 40. The weekend/holiday usage metric at 9 AM is approximately 20.

At 316, the server can establish an auto-scale setting. The auto-scale setting can refer to determining how many VDA sessions to pre-launch for a time frame. The number of sessions to pre-launch can correspond to the usage metric or safety line value for the time interval. The auto-scale setting can be based on an estimated safety line for a time frame and a safety buffer value. The initial auto-scale setting can be the safety line value Fₜ for the upcoming time interval. The auto-scale setting can be used at checkpoints within a time frame to determine whether to launch additional VDAs beyond the initial safety line estimate based on the actual request density (e.g., number of requests received during a time segment in the time frame, such as 40 requests in the first 10 minutes).

At ACT 318, the server can control a pool of VDAs. The server can use the auto-scale settings established at ACT 316 to pre-launch VDAs and make them available in a pool of VDAs for future session requests. The server can control the number of available VDAs in the pool ahead of each time frame, and also control the number of available VDAs at checkpoints during the time frame. Controlling the pool of VDAs can refer to preparing and launching a certain number of VDAs (e.g., the estimated safety line value for the time frame) before a time frame. The server 318 can generate tokens that are used by a pool manager service to launch VDAs. For example, the auto-scaler can generate a number of tokens determined based on the auto-scale setting, and store them in a data store. The pool manager server can identify the tokens in the data store, and prepare and launch a VDA for each token in the data store. Thus, rather than wait for a request to come in from a client device and then generate a token responsive to the actual request from the client device, the auto-scaler of this technical solution can automatically generate tokens for a subsequent time frame independent of requests received from client devices during the time frame. The automatically generated tokens can cause the pool manager service to launch and prepare VDA sessions prior to receiving a request from a client device for the VDA session.

At ACT 320, the server can monitor consumption. The server can monitor actual consumption in real-time. The server can determine the number of requests received during a time frame or one or more time segments in the time frame. The server can receive indications of requests to establish sessions. The server can determine whether the request was successful and resulted in usage of a VDA session from the pool of VDAs. The server can determine a request density, such as a number of requests received during a time frame or time segment. For example, the request density for a time frame can be the number of successful requests during a time frame, such as 30 minutes. A request density for a time segment can be the number of requests received during one or more time segments, such as the first 5 minutes of the time frame, the first 10 minutes of the time frame, the first 15 minutes of the time frame, the 20 minutes of the time frame, or the 25 minutes of the time frame.

The server can continuously monitor consumption, or monitor consumption at discrete time intervals (e.g., checkpoints within the time frame). The server can determine the consumption (e.g., number of successful requests) at each checkpoint within a time frame and before the beginning of a subsequent time frame.

At decision block 322, the server can determine whether a spike was detected. If no spike was detected, the server can return to ACT 320 to continuing monitoring consumption. If the server detects a spike at decision block 322, the server can proceed to ACT 324 to add a safety buffer. The server can detect a spike based on the auto-scale setting. The server can detect a spike if a trend indicated by the request density (e.g., number of requests received up to a checkpoint in the time frame) continues throughout the time frame would result in an insufficient number of VDAs being available in the pool. The server can compare the request density or number of requests received (e.g., Rₜ) with a value determined based on the safety line estimate for the time frame and a safety buffer value. For example, the server can compare Rₜ with the value determined from Fₜ*(t/time_frame)+(m+1)*a. If the server determines at decision block 322 that Rₜ (determined via ACT 320) is less than or equal to Fₜ*(t/time_frame)+(m+1)*a, then the server can return to ACT 320 to continue monitoring consumption. However, if the server determines at decision block 322 that Rₜ (determined via ACT 320) is greater than Fₜ*(t/time_frame)+(m+1)*a, then the server can proceed to ACT 324 to add a safety buffer.

At ACT 324, the server can add a safety buffer. Adding a safety buffer can include determining a safety buffer value a, which can be based on the estimated or forecasted safety line (e.g., statistical value based on the safety line) or some other predetermined or fixed value. The server can perform a lookup in a settings or usage metrics data structure to determine the safety buffer value. Upon determining the safety buffer value a, and detecting a spike at the checkpoint, the server can prepare and prelaunch an additional a number of VDA sessions to add to the pool of available VDAs. The server can return to ACT 318 to control the pool of VDAs by adding a number of VDAs to the pool.

In some cases, the server can detect a spike at 322, but determine not to add a safety buffer. The server can determine the spike at 322 is due to a malicious or fraudulent actor. The server can determine the spike is due to a malicious actor (or is otherwise a spike in request density that should not trigger an addition of a safety buffer) based on one or more characteristics associated with the request density. For example, the server can determine the spike is due to a malicious actor based on the request density falling greater than 3 standard deviations outside the estimated safety line and all the requests being associated with the same client device, group of client devices, domain, internet protocol address (e.g., an IP address listed as a malicious actor in a database), entity, organization, or geographic location. If the server determines at ACT 322 that the spike is due to a malicious actor, the server can determine to terminate the session requests associated with the malicious actor, thereby freeing up VDAs in the pool of VDAs. The server can further determine not to add a safety buffer to launch additional VDAs, thereby reducing or avoiding wasted computing resource consumption. The server, responsive to detecting the spike is may be due to a malicious actor, can initiate a firewall block to prevent further requests from the malicious client device or IP address from using VDAs from the pool. The server can establish the firewall block for a predetermined amount of time (e.g., a time frame or multiple time frames) or indefinitely until an administrator of the system evaluates the firewall block for the client device and determines whether to remove the block.

FIG. 4 is an example of a fitting curve used to automatically scale a pool of VDAs. The graph 400 illustrates daily usage fitting curves that include a separate weekday fitting curve 402 and a weekend/holiday fitting curve 404. The graph 400 includes a y-axis or vertical axis that indicates the number of requests, and an x-axis or horizontal axis that indicates time. The graph 400 illustrates a 24-hour day. The weekday fitting curve 402 and weekend/holiday fitting curve 404 can be generated by the auto-scaler 206 based on historical consumption data 226. The fitting curves 402 and 404 can be generated by filtering the consumption data for the past month (e.g., previous 30 days) to identify respective weekday and weekend/holiday data, and then using a fitting technique and/or deep learning technique to generate the fitting curves. The number of requests can present a regular distribution over time, which can be represented as fₜ=Sₜ+Cₜ, where Sₜ corresponds to seasonal cycling data (or weekly cycling data), and Cₜ corresponds to daily cycling data.

For example, a moving average technique can remove the random components, and a machine learning technique or deep learning technique can smooth the data to generate a fitting result for weekday data. Thereafter, a sinusoidal regression technique can be used to determine the weekly cycling data. The system can use deep learning to then remove a weekly seasonal usage trend from the weekly cycling data to generate a weekly fitting curve for weekdays. Thus, FIG. 4 represents a weekday fitting curve 402 and a weekend/holiday fitting curve 404 as a result of this processing.

FIG. 5 is an example of a safety line used to automatically scale a pool of VDAs. The safety line graph 500 can include a weekday safety line 502 and a weekend/holiday safety line 504. The weekday safety line 502 and weekday/holiday safety line 504 can be stored in usage metrics 230 data structure. The usage metric used to perform auto-scaling can be based on or determined from a weekday safety line 502 or a weekend/holiday safety line 504.

The server 202 can set up safety lines 502 and 504 according to the respective daily usage fitting curves 402 and 404 depicted in FIG. 4. An example time interval can be 30 minutes. The safety lines 502 and 504 can indicates how many VDA sessions the pool manager 216 is to prelaunch at each 30 minutes check point. The safety line time distribution formula can be Fₜ=fₜ+Lₜ, where fₜ refers to a daily cycle fitting curve (e.g., weekday fitting curve 402 and weekend/holiday fitting curve 404) and Lₜ refers to the random part of the usage data Rₜ.

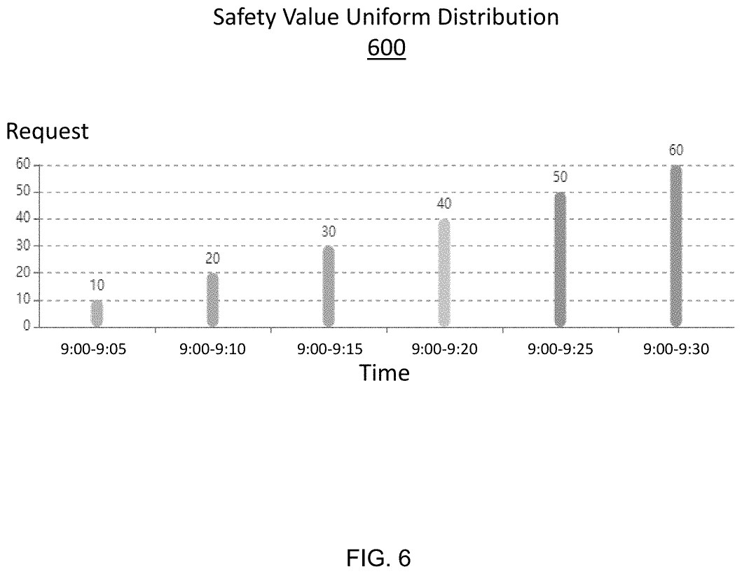

FIG. 6 is an example of a distribution of safety values used to automatically scale a pool of VDAs. The example safety value uniform distribution 600 depicted in FIG. 6 includes a time frame that is 30-minutes from 9 AM to 9:30 AM. The time frame can be 20 minutes, 40 minutes, or some other duration. The example 30-minute time frame can correspond to a weekday. To prevent the technical problem of having an insufficient number of VDA sessions available in the pool 222, which can be caused by an abnormally large number of log in requests, the system 200 can utilize real-time protection mechanisms that can check the request count every 5 minutes (or some other time interval that is a subset of the time frame). The real-time protection mechanism (which can be performed by spike monitor 214 or auto-scaler 206) can determine whether pre-launch additional VDA sessions in the pool.

For example, the auto-scaler 206 can determine a usage metric for a time frame based on a weekday safety line 502 or weekend safety line 504 as in FIG. 5 and referred to as Fₜ. Example usage metrics for a 30-minute time frame beginning at 9 AM on a weekday can be Fₜ=60 with a safety buffer value a=10. The system 200 can, therefore, determine to prelaunch 60 VDA sessions at 9:00 AM. In some cases, the system 200 can pre-launch all 60 VDA sessions at the beginning of the time frame (e.g., at 9 AM). In some cases, rather than pre-launch all 60 sessions at the beginning of the time frame, the system 200 can stagger or distribute the VDA sessions launches uniformly throughout the time frame. For example, the system 200 can expect the visit traffic to be evenly distributed within the thirty minute time frame. The system 200 can divide the time frame into equal parts or time segments (e.g., 6 equal parts of 5 minutes each for a 30-minute time frame, or some other number of equal parts). If the time frame is divided into 6 time segments, FIG. 6 illustrates the predict safety value time distribution are as 10 from 9:00 to 9:05 AM, 20 from 9:00 to 9:10, 30 from 9:00 to 9:15, 40 from 9:00 to 9:20, 50 from 9:00 to 9:25 and 60 from 9:00 to 9:30 AM.

The estimated safety value at each checkpoint can be referred to as Eₜ and determined based on the following function: Eₜ=(Fₜ)*t/(time_frame_duration). The estimated safety value at a checkpoint can be based on the safety line, checkpoint time segment, and duration of the time frame. The estimated safety value at a checkpoint can be a product of the safety line value for the time frame and a ratio of the time segment to the time frame duration. For example, if safety line Fₜ for a time frame having a 30 minute duration at 9 AM is 60, then after a 5 minute time segment, E₅=60*5/30=10; after two 5 minute time segments, E₁₀=60*10/30=20; after three 5 minute time segments, E₁₅=60*15/30=30; and after all 6 time segments, E₃₀=60*30/30=60.

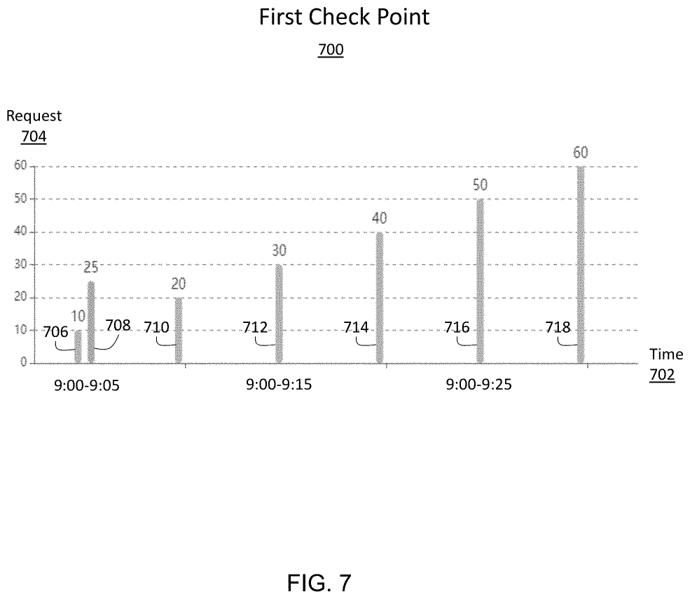

FIG. 7 is an example of a check point to automatically scale a pool of VDAs. The first checkpoint diagram 700 illustrates Eₜ for each of the 6 time segments as indicated in FIG. 6. The y-axis or vertical axis 704 indicates the number of requests (either estimated or real). The x-axis or horizontal axis 702 represents time. For example, E₅=10 (706); E₁₀=20 (710); E₁₅=30 (712); E₂₀=40 (714); E₂₅=50 (716); E₃₀=60 (718). The first checkpoint can correspond to 9:00 to 9:05. The estimated value at the first checkpoint is E₅=10 (706).

The real number of requests at the first checkpoint can be 25 (708). The server 202 can compare the real number of requests Rₜ received at the first checkpoint with the estimated number for the checkpoint based on the forecasted safety line Fₜ, as well as the safety buffer value a. For example, the server 202 (e.g., auto-scaler 206 or spike monitor 214) can execute a spike detection mechanism at each checkpoint within the pre-launch time frame. At the first checkpoint of the time frame, the server 202 can determine E₅=10 (706) and Rₜ=25 (708). The server 202 can perform a check or comparison at the first checkpoint to determine if the real number of requests is greater than the estimated value and a safety buffer value as follows: Rₜ>Eₜ+(m+1)*a, where m is the number of times an extra number of a sessions were added. The comparison can be between the real requests and the estimated value plus the safety value buffer because the server 202 can be configured to maintain the safety buffer to mitigate spikes (e.g., three standard deviations which accounts for 99.99% of Fₜ values).

At the first checkpoint, no additional sessions have been added, so m=0. Also in this example, the safety buffer value a=10 (which can correspond to 3 standard deviations of Fₜ, for example). In this example first checkpoint, R₅ is greater as follows: 25>10+(0+1)*10=20. The real number of requests is 5 more than the estimated number plus the safety buffer value.

The server 202 can determine that if this trends continues, the available VDAs in the pool of VDAs, which is configured to prelaunch Eₜ+a sessions, will be consumed prior to completion of the 30 minute time interval. Accordingly, the system can determine to prepare a additional sessions at this point. The number of additional sessions to prepare, a, can be set based on the safety buffer value determined from Fₜ. Accordingly, after the first checkpoint, and responsive to the comparison in which Rₜ is greater, the server 202 can determine to pre-launch a (or 10) additional VDA sessions. Thus, the server 202 can determine, based on the auto-scale setting of the pool (e.g., a function of the estimated safety line for the time segment and the safety buffer value), to increase the number of active virtual delivery agents in the pool for the future time frame, and pre-launch, responsive to the determination, one or more virtual delivery agents (e.g., safety buffer value a) in accordance with the auto-scale setting.

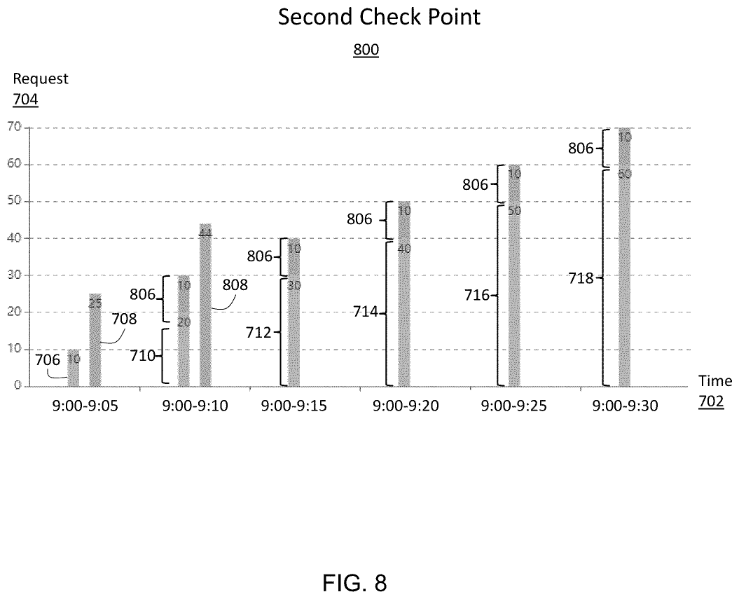

FIG. 8 is an example of a check point to automatically scale a pool of VDAs. The second checkpoint 800 illustrated in FIG. 8 corresponds to 10 minutes or two segments into the 30-minute time fame. Due to the results of the comparison at the first checkpoint, the server 202 launched an additional a number of VDA sessions, which is illustrated as 806. This additional safety buffer a (806) is taken into account when evaluating each of the subsequent checkpoints. Thus, the comparison made by server 202 at the second checkpoint is whether the real number of requests R₁₀ is greater than E₁₀ plus the safety buffer value and plus any safety buffer values added from previous checkpoints as follows: R₁₀>E₁₀+(m+1)*a. In this example, R₁₀=44 (808), and is greater than 20+(1+1)*10=40. Responsive to server 202 determining at the second checkpoint that the number of real requests is greater than the estimated safety value (710) plus the safety buffer value a and the number of additional safety buffer values added during previous checkpoint (indicated by 806), the server 202 can determine to pre-launch an additional safety buffer value a number of VDA sessions to add to the pool of available VDAs.

Thus, at the second checkpoint, which is five minutes after the first checkpoint or 10 minutes from the beginning of the time interval, the server 202 can determine the number of session requests that were received in the first 10 minutes (R₁₀). Since a additional sessions were prepared after the first checkpoint, the system can determine whether R₁₀−a is greater than

$${F}_{t} * \frac{10}{30} + a .$$

If R₁₀−a is greater than

$${F}_{t} * \frac{10}{30} + a ,$$

then the system can determine to prepare a number of additional VDA sessions. The server 202 can, after each checkpoint, determine whether at the current trend of requests the number of VDA sessions pre-launched for this time frame would be insufficient.

For example, the server 202 can determine, for the auto-scale setting, a safety buffer value of virtual delivery agents based on the usage metric (e.g., safety line Fₜ) and a standard deviation (e.g., three standard deviations of Fₜ) of the usage metric for the time frames of the historical data. The server 202 can detect a request density for a current time frame, such as the number of requests that have been received by the checkpoint (e.g., 44 requests received in first 10 minutes). The server 202 can determine, based on the request density (e.g., R₁₀=44) and the safety line and the safety buffer, to initiate a second safety buffer for the future time frame (e.g., in advance of the third checkpoint or next time segment in the 30-minute time frame). The server 202 can determine to initiate the second safety buffer if R₁₀>E₁₀+(m+1)*a, which it is in this case. The server 202 can initiate, responsive to the determination, the second safety buffer to increase the number of active virtual delivery agents in the pool during the future time frame.

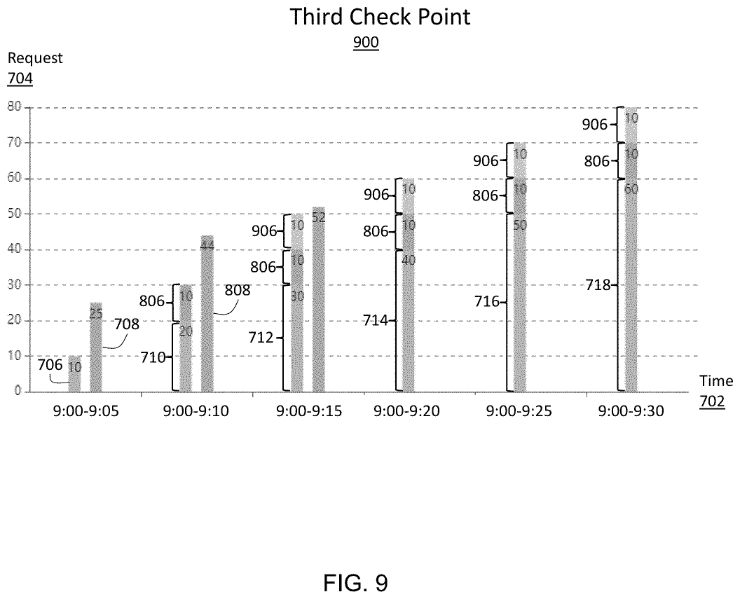

FIG. 9 is an example of a check point to automatically scale a pool of VDAs. FIG. 9 illustrates a third check point diagram 900. The third check point corresponds to three time segments into the time frame, e.g., t=15 or from 9:00 to 9:15. By the third checkpoint, the estimated safety line value Et=Fₜ*(t/30)=60*(15/30)=30 (712). The number of additional safety buffer values already added at the first two checkpoints is 10 (806)+10 (906). The number of real requests at the third checkpoint R₁₅=52. The server 202 can determine at the third checkpoint whether to prelaunch an additional safety buffer value number of VDA sessions for the pool of available VDAs. To determine whether to prelaunch additional VDAs, the server 202 can determine whether R₁₅ is greater than E₁₅+(m+1)*a. For the third checkpoint, R₁₅=52, E₁₅=30, m=2, and a=10. Therefore R₁₅=52<30+(2+1)*10=60. Responsive to determining that the actual usage (or real number of successful requests or log ins or number of sessions being utilized) of VDA sessions at the third checkpoint is less than the estimated safety line value plus the number of additional VDA sessions launched at previous checkpoints plus the safety buffer value, the server 202 can determine not to prelaunch an additional safety buffer value a number of VDA sessions for addition to the pool. The server 202 can determine not to launch additional VDA sessions at the third checkpoint because the server 202 can determine, at the current trend based on the third checkpoint, that the pool contains a sufficient number of pre-launched VDAs. By determining not to pre-launch additional VDAs, the server 202 can reduce computing resource consumption, memory usage, processor utilization, network bandwidth utilization.

FIG. 10 is an example of a neural network for automatically scaling a pool of VDAs. The neural network 1000 includes a hidden layer 1004 and an output layer 1006. The hidden layer 1004 can receive input 1002, and the output layer 1006 can provide output 1008. The neural network 1000 can be part of the auto-scaler 206, or a component thereof, such as the usage curve generator 210 or consumption analyzer 208. For example, the usage curve generator 210 can be configured with a machine learning or deep learning engine corresponding to the neural network 1000.

Input 1002 to the hidden layer 1004 can include usage data Rₜ which can corresponds to historic or previous successful sessions requests. The usage data Rₜ can be filtered, grouped, or pre-processed by the consumption analyzer 208 prior to being input into the hidden layer 1004. For example, the usage data may only include weekday usage data, or weekend/holiday usage data.

The neural network 1000 can be configured to separate out the parts of the usage data into a seasonal weekly cycling data Sₜ, daily cycling data Cₜ and a random part Lₜ. For example, to separate out these 3 parts from the usage data, the neural network 1000 can be a 2 layer feed-forward network. The hidden layer 1004 can include sigmoid hidden neurons, and the output layer 1006 can include linear output neurons (function fitting neural network) deep learning function to generate a fitting result that can smooth the data and get rid of Lₜ.

The hidden layer 1004 can include sigmoid neurons can receive usage data as input 1002. Every input data point can have a weight W 1010 that can indicate the importance of the input in the decision making process. A bias b 1012 can also be applied to the input 1002. The input with the weight W 1010 and bias 1012 can be summed at 1014. In the sigmoid neuron layer, a small change in the input 1002 causes only a small change in the intermediary output 1016. The intermediary output 1016 can refer to the output of the hidden layer 1004. For example, the sigmoid neuron layer can use the following logistic function

$$y = \frac{1}{1 + {e}^{- ( {w}^{T} + b )}} ,$$

where b (e.g., b 1012) corresponds to a transition threshold and w corresponds to a weight applied to the input.

In some cases, the system 200 can learn the parameters w 1010 and b 1012 using a gradient descent function. For example, w and b can be initialized randomly. The system 200 can then iterate over all the observations in the data, and find, for each observation, the corresponding predicted outcome using the sigmoid function and compute the squared error loss. Based on the loss value, the system can update the weights w 1010 such that the overall loss of the model at the new parameters can be less than the current loss of the model.

The output layer 1006 can include linear output neurons. In linear output neurons configuration, the output 1024 is a weighted (W 1018) sum (1022) of its inputs plus a bias term (b 1020). The values of W 1018 and b 1020 can be the same or different from W 1010 and b 1012 in the hidden layer 1004.

Using the neural network 1000, the server 202 can remove the random part Lₜ from the usage data. By removing Lₜ, the neural network 1000 can obtain the usage trend, resulting in Dₜ. Dₜ can represent the usage baseline because the deep learning neural network 1000 may filter out short-term usage fluctuations. The input 1002 can be the raw data 1106 illustrated in FIG. 11, and the output 1008 of the neural network 1000 can be the fitting result 1108 illustrated in FIG. 11.

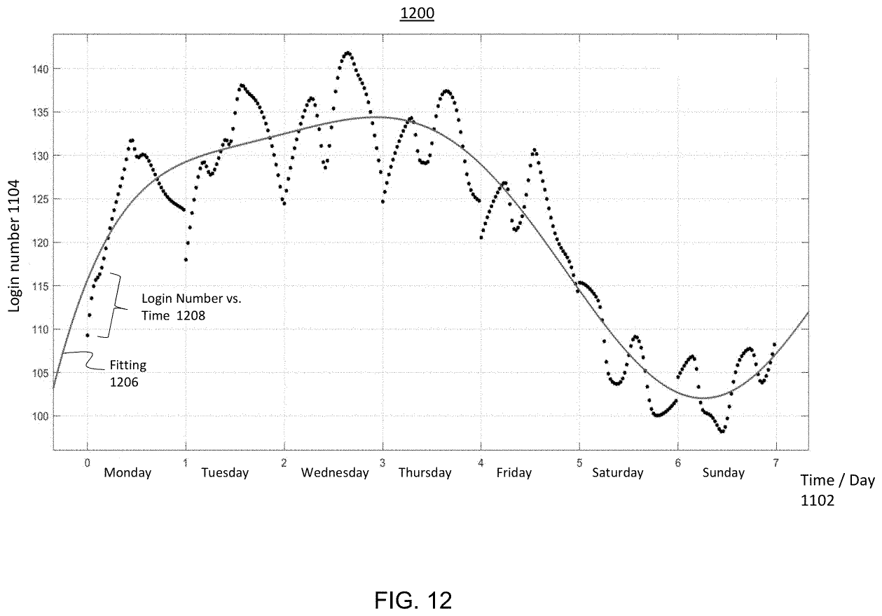

The server 202 can also use the neural network to determine the cycling curve Cₜ. For example, having found Dₜ, the server 202 can use a sinusoidal regression to determine the weekly seasonal data Sₜ from Dₜ as illustrated by fitting 1206 in FIG. 12. To remove the seasonal usage trend and obtain the weekly fitting result, the server 202 can subtract Sₜ from the usage data Rₜ. The server 202 can then input Rt−St as input 1002 to the neural network 1000 to obtain an output 1008 that is a weekly fitting result without weekly seasonal usage trend, as illustrated by the fitting result 1304 in FIG. 13.

FIG. 11 is an example of data used to automatically scale a pool of VDAs. The graph 1100 illustrates raw data 1106. Raw data 1106 can refer to consumption data, such as consumption data 226. The raw data 1106 can include all consumption data, a subset of the consumption data, or filtered consumption data. For example, the raw data 1106 in graph 1100 may be filtered to remove weekend data, holiday data, or other types of data.

The graph 1100 illustrates the time/day 1102 in the X-axis (e.g., horizontal axis). The y-axis (or vertical axis) represents the login number 1104 (e.g., number of session requests or successful session requests). The axis corresponding to time/day 1102 can indicate one or more weeks, such as week 1 (1110) and week 2 (1112).

The raw data 1106 can include cycling data (e.g., Cₜ and Sₜ) as well as random noise or irregular data (e.g., Lₜ). The auto-scaler 206, using deep learning (e.g., feed-forward network with sigmoid hidden neurons and linear output neurons as illustrated in FIG. 10), can filter out short-term usage fluctuations (e.g., spikes in the raw data 1106) to generate a fitting result 1108. The fitting result 1108 may not include spikes or random noise or irregularities present in the raw data 1106.

FIG. 12 is an example of a fitting curve used to automatically scale a pool of VDAs. The graph 1200 illustrates a fitting curve 1206 generated based on the fitting result 1108 depicted in FIG. 11. A subset of the fitting result 1108 is represented as login number versus time 1208 in graph 1200. This subset can corresponds to a 7-day week from Monday through Sunday, such as week 1 (1110) or week 2 (1112) illustrated in FIG. 11. The fitting result can be generating using a sinusoidal regression. For example, a 3-level sinusoidal regression f(x)=a1*sin(b1*x+c1)+a2*sin(b2*x+c2)+a3*sin(b3*x+c3), where x is normalized by mean 3.49 and standard deviation 2.024 can have the following coefficients (with 95% confidence bounds):

a1=378.3(−1.162e+05, 1.17e+05)

b1=0.9386(−51.41, 53.28)

c1=1.265(−27.41, 29.94)

a2=4703(−9.721e+08, 9.721e+08)

b2=1.518(−2253, 2256)

c2=−2.052(−290.2, 286.1)

a3=4452(−9.722e+08, 9.722e+08)

b3=1.539(−2189, 2192)

c3=1.087(−260.2, 262.4).

The goodness of fit can be: sum of squares error (SSE): 5012, R-square: 0.8999, Adjusted R-square: 0.8975, and root mean squared error (RMSE): 3.915.

FIG. 13 is an example of a fitting curve used to automatically scale a pool of VDAs. The graph 1300 can illustrate a weekly fitting result 1304 after the auto-scaler 206 removes a weekly seasonal usage trend from the fitting 1206 curve illustrated in FIG. 12. Upon identify Sₜ from Dₜ (which does not include the random part Lₜ) using a sinusoidal regression technique, the auto-scaler 206 can identify the daily cycling part Cₜ by subtracting Sₜ from Rₜ (e.g., Rₜ−Sₜ) and using a deep learning technique as illustrated in FIG. 10 to remove the weekly seasonal usage trend and generate a weekly fitting result 1206 as illustrated in graph 1300 of FIG. 13.

FIG. 14 is an example of a normal probability plot used to automatically scale a pool of VDAs. The normal probability plot can be used to verify or validate data or hypothesis. For example, the random part Lₜ of the usage data Rₜ can be removed to generate Dₜ using moving average or machine learning techniques such as deep learning. The random part Lₜ may not itself be predicable, but the auto-scaler 206 can be configured to measure the random part Lₜ. For example, the Rₜ usage data corresponds to a normal distribution when the same time frames from different workdays are compared with one another. Since the Rₜ corresponds to a normal distribution, the auto-scaler 206 can use two standard deviations to estimate the Fₜ value range.

FIG. 15 is an example of a forecasting result used to automatically scale a pool of VDAs. The graph 1500 illustrates a forecasting result 1502 that corresponds to Fₜ generated as a combination of the fitting curves and fitting results as follows: Fₜ=Sₜ+Cₜ+Lₜ. The graph 1500 further illustrates the raw data 1106 (which can correspond to raw data 1106 of FIG. 11) which includes data for week 1 (1110) and week 2 (1112). The forecasting result 1502 can be used by the server 202 as a safety line to estimate the number of VDAs to pre-launch for a time frame.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method of auto-scaling virtual delivery agent services, comprising:
identifying, by one or more processors, data indicating consumption of a pool of active virtual delivery agents over a plurality of previous time frames;
determining, by the one or more processors, a usage metric for a time frame of the plurality of previous time frames based on the data indicating consumption of the pool of active virtual delivery agents; and
controlling, by the one or more processors responsive to an auto-scale setting of the pool based on the usage metric, a number of active virtual delivery agents in the pool for a future time frame that corresponds to the time frame of the plurality of previous time frames.

2. The method of claim 1, wherein the data indicating the consumption includes a time series of requests to access services provided via the pool over the plurality of previous time frames.

3. The method of claim 1, comprising:
generating a fitting curve based on the data indicating consumption of the pool of active virtual delivery agents; and
determining the usage metric based on the fitting curve, wherein the usage metric indicates a number of requests for services provided via virtual delivery agents predicted to occur in the future time frame and prior to receipt of the requests for the services provided via the virtual delivery agents.

4. The method of claim 1, comprising:
filtering the data indicating consumption of the pool of active virtual delivery agents by removing time frames corresponding to weekends and holidays;
generating a fitting curve based on the filtered data; and
determining the usage metric based on the fitting curve generated based on the filtered data.

5. The method of claim 1, comprising:
filtering the data by removing one or more types of time frames;
inputting the filtered data into a machine learning component to generate a weekly fitting curve and a daily fitting curve.

6. The method of claim 1, comprising:
establishing a safety buffer of virtual delivery agents based on the usage metric and a standard deviation of the usage metric for the plurality of previous time frames; and
establishing the auto-scale setting based on the safety buffer to control the number of active virtual delivery agents in the pool for the future time frame.

7. The method of claim 1, comprising:
determining, based on the auto-scale setting of the pool, to increase the number of active virtual delivery agents in the pool for the future time frame; and
pre-launching, responsive to the determination, one or more virtual delivery agents in accordance with the auto-scale setting.

8. The method of claim 1, comprising:
determining, for the auto-scale setting, a safety buffer of virtual delivery agents based on the usage metric and a standard deviation of the usage metric for the plurality of previous time frames;
detecting a request density for a current time frame;
determining, based on the request density and the safety buffer, to initiate a second safety buffer for the future time frame; and
initiating, responsive to the determination, the second safety buffer to increase the number of active virtual delivery agents in the pool during the future time frame.

9. The method of claim 1, comprising:
generating, responsive to the auto-scale setting of the pool, a pre-launch token for the future time frame; and
providing the pre-launch token to a pool manager service to cause the pool manager service to launch a virtual delivery agent for the pre-launch token prior to receiving a session request from a client device.

10. The method of claim 1, comprising:
detecting a request density associated with a client device or a group of client devices associated with an entity; and
determining, based on the request density and the usage metric for the time frame, to disconnect the client device or the group of client devices to maintain a predetermined number of active virtual delivery agents in the pool for the future time frame.

11. A system to auto-scale virtual delivery agent services, comprising:
a device comprising one or more processors configured to:
identify data indicating consumption of a pool of active virtual delivery agents over a plurality of previous time frames;
determine a usage metric for a time frame of the plurality of previous time frames based on the data indicating consumption of the pool of active virtual delivery agents; and
control, responsive to an auto-scale setting of the pool based on the usage metric, a number of active virtual delivery agents in the pool for a future time frame that corresponds to the time frame of the plurality of previous time frames.

12. The system of claim 11, wherein the data indicating the consumption includes a time series of requests to access services provided via the pool over the plurality of previous time frames.

13. The system of claim 11, wherein the device is configured to:
generate a fitting curve based on the data indicating consumption of the pool of active virtual delivery agents; and
determine the usage metric based on the fitting curve, wherein the usage metric indicates a number of requests for services provided via virtual delivery agents predicted to occur in the future time frame and prior to receipt of the requests for the services provided via the virtual delivery agents.

14. The system of claim 11, wherein the device is configured to:
filter the data indicating consumption of the pool of active virtual delivery agents by removing time frames corresponding to weekends and holidays;
generate a fitting curve based on the filtered data; and
determine the usage metric based on the fitting curve generated based on the filtered data.

15. The system of claim 11, wherein the device is configured to:
filter the data by removing one or more types of time frames;
input the filtered data into a machine learning component to generate a weekly fitting curve and a daily fitting curve.

16. The system of claim 11, wherein the device is configured to:
establish a safety buffer of virtual delivery agents based on the usage metric and a standard deviation of the usage metric for the plurality of previous time frames; and
establish the auto-scale setting based on the safety buffer to control the number of active virtual delivery agents in the pool for the future time frame.

17. The system of claim 11, wherein the device is configured to:
determine, based on the auto-scale setting of the pool, to increase the number of active virtual delivery agents in the pool for the future time frame; and
pre-launch, responsive to the determination, one or more virtual delivery agents in accordance with the auto-scale setting.

18. The system of claim 11, wherein the device is configured to:
determine, for the auto-scale setting, a safety buffer of virtual delivery agents based on the usage metric and a standard deviation of the usage metric for the plurality of previous time frames;
detect a request density for a current time frame;
determine, based on the request density and the safety buffer, to initiate a second safety buffer for the future time frame; and
initiate, responsive to the determination, the second safety buffer to increase the number of active virtual delivery agents in the pool during the future time frame.

19. The system of claim 11, wherein the device is configured to:
generate, responsive to the auto-scale setting of the pool, a pre-launch token for the future time frame; and
provide the pre-launch token to a pool manager service to cause the pool manager service to launch a virtual delivery agent for the pre-launch token prior to receiving a session request from a client device.

20. The system of claim 11, wherein the device is configured to:
detect a request density associated with a client device or a group of client devices associated with an entity; and
determine, based on the request density and the usage metric for the time frame, to disconnect the client device or the group of client devices to maintain a predetermined number of active virtual delivery agents in the pool for the future time frame.
